(19) United States
(12) Patent Application Publication
(10) Pub. No.: US 2026/0156674 A1
(43) Pub. Date: Jun. 4, 2026

(54) ENABLING PROPER RECEPTION OF TRANSMISSION OPPORTUNITY (TXOP) RETURN FRAMES IN COORDINATED TIME DIVISION MULTIPLE ACCESS (C-TDMA)

(71) Applicant: NEWRACOM, Inc., Irvine, CA (US)

(72) Inventors: Si-Chan NOH, Seoul (KR); Joonsoo LEE, Irvine, CA (US)

(73) Assignee: NEWRACOM, Inc., Irvine, CA (US)

(21) Appl. No.: 19/397,367

(22) Filed: Nov. 21, 2025

Related U.S. Application Data
(60) Provisional application No. 63/727,165, filed on Dec. 2, 2024.

(51) Int. Cl. H04W 74/04

(52) U.S. Cl. CPC H04W 74/04

(57) ABSTRACT

Disclosed herein is a method performed by a sharing access point (AP) to be able to receive a transmission opportunity (TXOP) return frame during coordinated time division multiple access. The method includes providing a temporary channel access parameter set (TCAPS) to a station (STA) associated with the sharing AP, wherein the TCAPS includes a duration parameter indicating a duration for which the STA is to apply the TCAPS, wherein the duration is sufficiently long to encompass a portion of a TXOP that is to be allocated to a shared AP. The method further includes performing a frame exchange with the STA that causes the STA to apply the TCAPS for the duration, transmitting a TXOP sharing frame to the shared AP to allocate the portion of the TXOP to the shared AP, and receiving the TXOP return frame from the shared AP.

### CROSS-REFERENCE TO RELATED APPLICATION

This application claims the benefit of U.S. Provisional Application No. 63/727,165, filed December 2, 2024, titled “Enhanced MU EDCA and RTS Enablement for Efficient Reception of TXOP Return Frames in Multi-AP Systems”, which is hereby incorporated by reference.

### TECHNICAL FIELD

The present disclosure generally relates to wireless communications, and more specifically, relates to enabling proper reception of transmission opportunity (TXOP) return frames in coordinated time division multiple access (C-TDMA).

### BACKGROUND

Institute of Electrical and Electronics Engineers (IEEE) 802.11 is a set of standards for implementing wireless local area network communication in various frequencies, including but not limited to the 2.4 gigahertz (GHz), 5 GHz, 6 GHz, and 60 GHz bands. These standards define the protocols that enable Wi-Fi devices to communicate with each other. The IEEE 802.11 family of standards has evolved over time to accommodate higher data rates, improved security, and better performance in different environments. Some of the most widely used standards include 802.11a, 802.11b, 802.11g, 802.11n, 802.11ac, and 802.11ax (also known as “Wi-Fi 6”). These standards specify the modulation techniques, channel bandwidths, and other technical aspects that facilitate interoperability between devices from various manufacturers. IEEE 802.11 has played an important role in the widespread adoption of wireless networking in homes, offices, and public spaces, enabling users to connect their devices to the internet and each other without the need for wired connections.

IEEE 802.11be, also known as “Wi-Fi 7”, is the next generation of the IEEE 802.11 family of standards for wireless local area networks. Currently under development, 802.11be aims to significantly improve upon the capabilities of its predecessor, 802.11ax/Wi-Fi 6, by offering even higher data rates, lower latency, and increased reliability. The standard is expected to leverage advanced technologies such as multi-link operation (MLO), which allows devices to simultaneously use multiple frequency bands and channels for enhanced performance and reliability. Additionally, 802.11be will introduce 4096-QAM (Quadrature Amplitude Modulation), enabling higher data rates by encoding more bits per symbol. The standard will also feature improved medium access control (MAC) efficiency, enhanced power saving capabilities, and better support for high-density environments. With these advancements, 802.11be is expected to deliver theoretical maximum data rates of up to 46 gigabits per second (Gbps), making it suitable for bandwidth-intensive applications such as virtual and augmented reality, 8K video streaming, and high-performance gaming.

Coordinated time division multiple access (C-TDMA or c-TDMA) is a multi-AP coordination scheme that allows an access point (AP) to share its transmission opportunity (TXOP) with other AP(s). For example, with c-TDMA, a first AP that owns a TXOP may share a portion of the TXOP with a second AP. The second AP may then transmit and receive in its basic service set (BSS) during its allocated portion of the TXOP. Stated differently, the first AP may allocate a portion of the TXOP to the second AP to allow the second AP to transmit and receive with its associated non-AP stations (STAs) during the allocated portion of the TXOP even though the second AP is not the original TXOP owner. If the second AP finishes transmission and reception before its allocated portion of the TXOP expires, the second AP may be allowed to return the TXOP to the first AP so that the first AP can resume the TXOP. In this TXOP sharing scenario, the first AP may be referred to as the sharing AP and the second AP may be referred to as the shared AP.

If the shared AP finishes transmission and reception with its associated STAs before its allocated portion of the sharing AP’s TXOP expires, the shared AP may attempt to transmit a TXOP return frame to the sharing AP to return the TXOP back to the sharing AP. During this process, a non-AP STA associated with the sharing AP but hidden from the shared AP may occupy the channel to transmit an uplink physical layer protocol data unit (UL PPDU) to the sharing AP. In this case, the UL PPDU and the TXOP return frame may collide with each other. As a result of the collision, the sharing AP may fail to receive the TXOP return frame and the TXOP is not returned. In this scenario, the transmission of the TXOP return frame essentially becomes meaningless. This can degrade the wireless network performance, as neither the sharing AP nor the shared AP will be able to use the remaining time in the sharing AP’s TXOP.

### BRIEF DESCRIPTION OF THE DRAWINGS

The disclosure will be more fully understood from the detailed description provided below and the accompanying drawings that depict various embodiments of the disclosure. However, these drawings should not be interpreted as limiting the disclosure to the specific embodiments shown; they are provided for explanation and understanding only.

FIG. 1 illustrates an example of a wireless local area network (WLAN) with a basic service set (BSS) that includes multiple wireless devices, in accordance with some embodiments of the present disclosure.

FIG. 2 is a schematic diagram of a wireless device, in accordance with some embodiments of the present disclosure.

FIG. 3A illustrates components of a wireless device configured to transmit data, in accordance with some embodiments of the present disclosure.

FIG. 3B illustrates components of a wireless device configured to receive data, in accordance with some embodiments of the present disclosure.

FIG. 4 illustrates interframe space (IFS) relationships, in accordance with some embodiments of the present disclosure.

FIG. 5 illustrates a Carrier Sense Multiple Access with Collision Avoidance (CSMA/CA)-based frame transmission procedure, in accordance with some embodiments of the present disclosure.

FIG. 6 illustrates maximum physical layer (PHY) rates for Institute of Electrical and Electronics Engineers (IEEE) 802.11 standards, in accordance with some embodiments of the present disclosure.

FIG. 7 provides a detailed description of fields in Extremely High Throughput (EHT) Physical Protocol Data Unit (PPDU) frames, including their purposes and characteristics, in accordance with some embodiments of the present disclosure.

FIG. 8 illustrates an example of multi-user (MU) transmission in Orthogonal Frequency-Division Multiple Access (OFDMA), in accordance with some embodiments of the present disclosure.

FIG. 9 illustrates an example of an access point sending a trigger frame to multiple associated stations and receiving Uplink Orthogonal Frequency-Division Multiple Access Trigger-Based Physical Protocol Data Units (UL OFDMA TB PPDUs) in response, in accordance with some embodiments of the present disclosure.

FIG. 10 is a diagram showing a coordinated time division multiple access (c-TDMA) scenario where transmission opportunity (TXOP) return is not allowed and the shared access point (AP) uses all of its allocated portion of the TXOP, according to some embodiments.

FIG. 11 is a diagram showing a c-TDMA scenario where TXOP return is allowed and the sharing AP resumes the TXOP after receiving a TXOP return frame from the shared AP, according to some embodiments.

FIG. 12 is a diagram showing a c-TDMA scenario where TXOP return is allowed and the sharing AP shares its TXOP with multiple APs in succession, according to some embodiments.

FIG. 13 is a diagram showing a duration/ID field included in the multi-user request-to-send TXOP sharing (MU-RTS TXS) frame being set to the sum of a clear-to-send (CTS) frame transmission duration and one short interframe space (SIFS) interval duration, according to some embodiments.

FIG. 14 is a diagram showing a polling phase and in-basic service set (BSS) frame exchange being performed before a TXOP allocation phase, according to some embodiments.

FIG. 15 is a diagram showing a format of a multi-user enhanced distributed channel access (MU EDCA) parameter set element, according to some embodiments.

FIG. 16 is a diagram showing a format of a high efficiency (HE) operation element field, according to some embodiments.

FIG. 17 is a diagram showing a situation where a TXOP return frame is not properly received due to interference, according to some embodiments.

FIG. 18 is a diagram showing three phases of a c-TDMA procedure, according to some embodiments.

FIG. 19 is a diagram showing an example of applying a MU EDCA parameter set to allow the sharing AP to properly receive a TXOP return frame, according to some embodiments.

FIG. 20 is a diagram showing an example of applying request-to-send (RTS) enablement to allow the sharing AP to properly receive a TXOP return frame, according to some embodiments.

FIG. 21 is a diagram showing an example of applying RTS enablement and where the sharing AP does not respond to a RTS frame, according to some embodiments.

FIG. 22 is a flow diagram showing a method for enabling proper reception of a TXOP return frame during c-TDMA, according to some embodiments.

### DETAILED DESCRIPTION

The present disclosure generally relates to wireless communications, and more specifically, relates to enabling proper reception of transmission opportunity (TXOP) return frames in coordinated time division multiple access (C-TDMA).

As mentioned above, if a shared AP finishes transmission and reception with its associated STAs before its allocated portion of the sharing AP’s TXOP expires, the shared AP may attempt to transmit a TXOP return frame to the sharing AP to return the TXOP back to the sharing AP. During this process, a non-AP STA associated with the sharing AP but hidden from the shared AP may occupy the channel to transmit an uplink physical layer protocol data unit (UL PPDU) to the sharing AP. In this case, the UL PPDU and the TXOP return frame may collide with each other. As a result of the collision, the sharing AP may fail to receive the TXOP return frame and the TXOP is not returned. In this scenario, the transmission of the TXOP return frame essentially becomes meaningless. This can degrade the wireless network performance, as neither the sharing AP nor the shared AP will be able to use the remaining time in the sharing AP’s TXOP.

The present disclosure describes a mechanism that allows the sharing AP to properly receive a TXOP return frame from the shared AP. The mechanism may prevent STAs associated with the sharing AP from transmitting UL PPDUs to the sharing AP during a portion of the sharing AP’s TXOP that is allocated to the shared AP or at least reduce the probability that the STAs transmit UL PPDUs to the sharing AP. The mechanism may achieve this by configuring STAs associated with the sharing AP with a temporary channel access parameter set and/or with a lower request-to-send (RTS) threshold. The mechanism may increase the probability that the sharing AP can successfully receive a TXOP return frame from the shared AP, which improves the multi-AP coordination efficiency during c-TDMA.

In an embodiment, the temporary channel access parameter set is a multi-user enhanced distributed channel access (MU EDCA) parameter set and the RTS threshold is a “dot11RTSthreshold” (e.g., as defined in pre-11ax IEEE 802.11 wireless networking standards) or a TXOP duration RTS threshold that is used for RTS enablement. Thus, embodiments may leverage the MU EDCA parameter set configuration and RTS enablement to prevent/reduce uplink interference from STAs associated with the sharing AP that are hidden to the shared AP.

According to some embodiments, a sharing AP provides a temporary channel access parameter set (e.g., MU EDCA parameter set) to a STA associated with the sharing AP. The temporary channel access parameter set may include a duration parameter (e.g., a MU EDCA timer parameter) indicating a duration for which the STA is to apply the temporary channel access parameter set. The duration may be sufficiently long to encompass a portion of a TXOP owned by the sharing AP that the sharing AP plans on allocating to a shared AP. The sharing AP may then perform a frame exchange with the STA (e.g., a trigger frame and uplink frame exchange) that causes the STA to apply the temporary channel access parameter set for the duration. Also, the sharing AP may provide a RTS threshold that is lower than a previously configured RTS threshold to a second STA associated with the sharing AP. The second STA is required to perform a RTS and clear-to-send (CTS) frame exchange before transmitting when the RTS threshold is met. Subsequently, the sharing AP may transmit a TXOP sharing frame to the shared AP to allocate a portion of the TXOP to the shared AP. The sharing AP may then receive a TXOP return frame from the shared AP and resume the TXOP in response to receiving the TXOP return frame.

Applying the temporary channel access parameter set may prevent the STA from transmitting a UL PPDU during the portion of the TXOP allocated to the shared AP or at least reduce the probability of transmitting a UL PPDU, thereby eliminating or reducing the probability of collision with a TXOP return frame transmitted by the shared AP to the sharing AP. Applying the lower RTS threshold may cause the second STA to transmit a RTS frame before transmitting a UL PPDU, and thus prevent the second STA from occupying the channel for a long period of time, thereby reducing the probability of collision with a TXOP return frame transmitted by the shared AP to the sharing AP.

For purposes of illustration, various embodiments are described herein in the context of wireless networks that are based on IEEE 802.11 standards and using terminology and concepts thereof. Those skilled in the art will appreciate that the embodiments disclosed herein can be modified/adapted for use in other types of wireless networks.

In the following detailed description, only certain embodiments of the present invention have been shown and described, simply by way of illustration. As those skilled in the art would realize, the described embodiments may be modified in different ways, all without departing from the spirit or scope of the present invention. Accordingly, the drawings and description are to be regarded as illustrative in nature and not restrictive. Like reference numerals designate like elements throughout the specification.

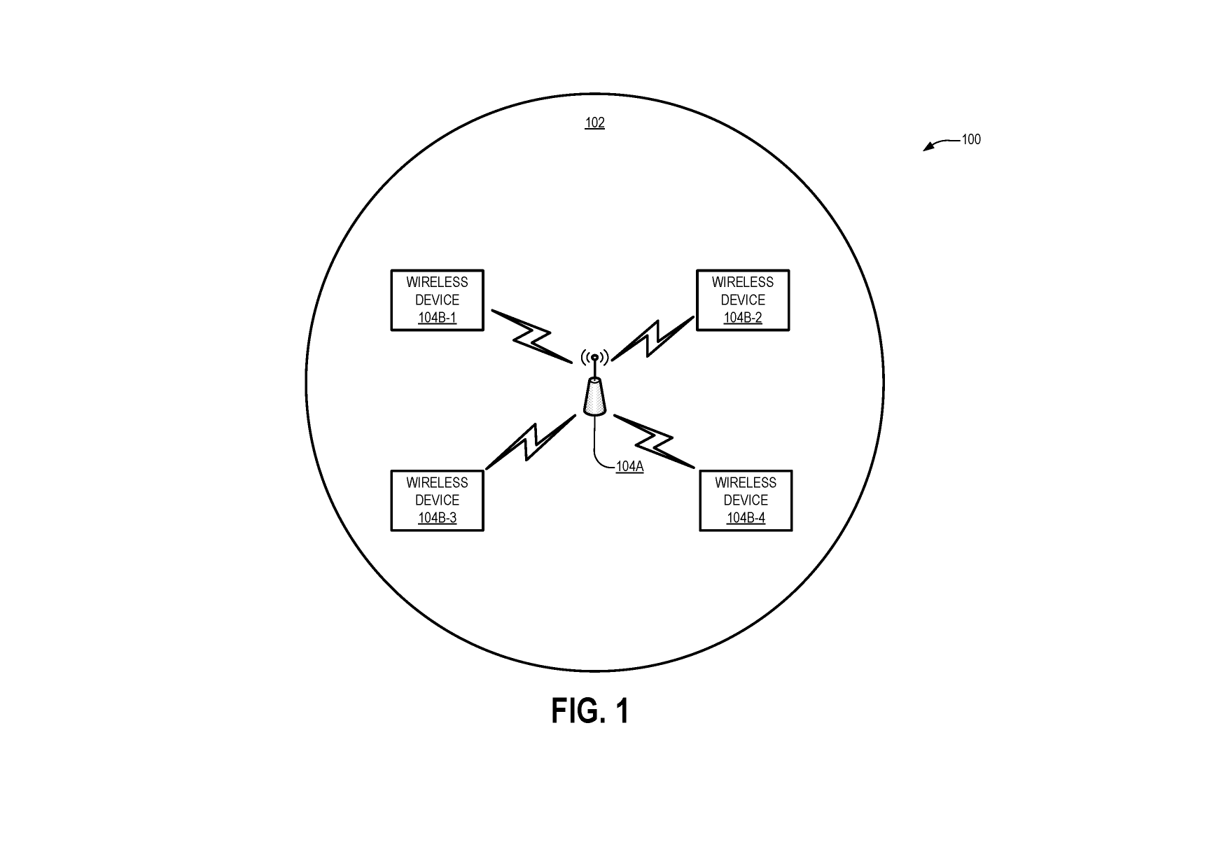

FIG. 1 shows a wireless local area network (WLAN) 100 with a basic service set (BSS) 102 that includes a plurality of wireless devices 104 (sometimes referred to as WLAN devices 104). Each of the wireless devices 104 may include a medium access control (MAC) layer and a physical (PHY) layer according to an IEEE (Institute of Electrical and Electronics Engineers) standard 802.11, including one or more of the amendments (e.g., 802.11a/b/g/n/p/ac/ax/bd/be). In one embodiment, the MAC layer of a wireless device 104 may initiate transmission of a frame to another wireless device 104 by passing a PHY-TXSTART.request (TXVECTOR) to the PHY layer. The TXVECTOR provides parameters for generating and/or transmitting a corresponding frame. Similarly, a PHY layer of a receiving wireless device may generate an RXVECTOR, which includes parameters of a received frame and is passed to a MAC layer for processing.

The plurality of wireless devices 104 may include a wireless device 104A that is an access point (sometimes referred to as an AP station or AP STA) and the other wireless devices 104B₁-104B₄ that are non-AP stations (sometimes referred to as non-AP STAs). Alternatively, all the plurality of wireless devices 104 may be non-AP STAs in an ad-hoc networking environment. In general, the AP STA (e.g., wireless device 104A) and the non-AP STAs (e.g., wireless devices 104B₁-104B₄) may be collectively referred to as STAs. However, for ease of description, only the non-AP STAs may be referred to as STAs unless the context indicates otherwise. Although shown with four non-AP STAs (e.g., the wireless devices 104B₁-104B₄), the WLAN 100 may include any number of non-AP STAs (e.g., one or more wireless devices 104B).

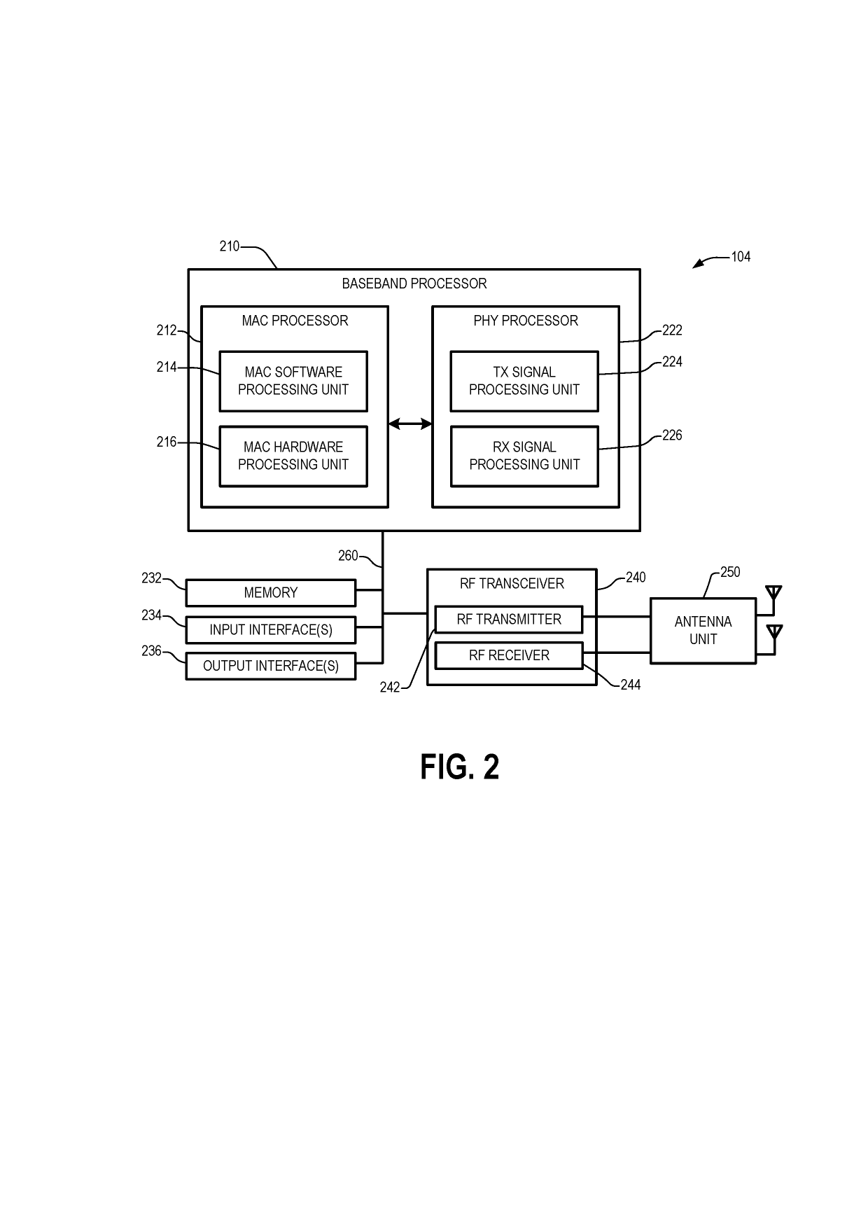

FIG. 2 illustrates a schematic block diagram of a wireless device 104, according to an embodiment. The wireless device 104 may be the wireless device 104A (i.e., the AP of the WLAN 100) or any of the wireless devices 104B₁-104B₄ in FIG. 1. The wireless device 104 includes a baseband processor 210, a radio frequency (RF) transceiver 240, an antenna unit 250, a storage device (e.g., memory device) 232, one or more input interfaces 234, and one or more output interfaces 236. The baseband processor 210, the storage device 232, the input interfaces 234, the output interfaces 236, and the RF transceiver 240 may communicate with each other via a bus 260.

The baseband processor 210 performs baseband signal processing and includes a MAC processor 212 and a PHY processor 222. The baseband processor 210 may utilize the memory 232, which may include a non-transitory computer/machine readable medium having software (e.g., computer/machine programing instructions) and data stored therein.

In an embodiment, the MAC processor 212 includes a MAC software processing unit 214 and a MAC hardware processing unit 216. The MAC software processing unit 214 may implement a first plurality of functions of the MAC layer by executing MAC software, which may be included in the software stored in the storage device 232. The MAC hardware processing unit 216 may implement a second plurality of functions of the MAC layer in special-purpose hardware. However, the MAC processor 212 is not limited thereto. For example, the MAC processor 212 may be configured to perform the first and second plurality of functions entirely in software or entirely in hardware according to an implementation.

The PHY processor 222 includes a transmitting (TX) signal processing unit (SPU) 224 and a receiving (RX) SPU 226. The PHY processor 222 implements a plurality of functions of the PHY layer. These functions may be performed in software, hardware, or a combination thereof according to an implementation.

Functions performed by the transmitting SPU 224 may include one or more of Forward Error Correction (FEC) encoding, stream parsing into one or more spatial streams, diversity encoding of the spatial streams into a plurality of space-time streams, spatial mapping of the space-time streams to transmit chains, inverse Fourier Transform (iFT) computation, Cyclic Prefix (CP) insertion to create a Guard Interval (GI), and the like. Functions performed by the receiving SPU 226 may include inverses of the functions performed by the transmitting SPU 224, such as GI removal, Fourier Transform computation, and the like.

The RF transceiver 240 includes an RF transmitter 242 and an RF receiver 244. The RF transceiver 240 is configured to transmit first information received from the baseband processor 210 to the WLAN 100 (e.g., to another WLAN device 104 of the WLAN 100) and provide second information received from the WLAN 100 (e.g., from another WLAN device 104 of the WLAN 100) to the baseband processor 210.

The antenna unit 250 includes one or more antennas. When Multiple-Input Multiple-Output (MIMO) or Multi-User MIMO (MU-MIMO) is used, the antenna unit 250 may include a plurality of antennas. In an embodiment, the antennas in the antenna unit 250 may operate as a beam-formed antenna array. In an embodiment, the antennas in the antenna unit 250 may be directional antennas, which may be fixed or steerable.

The input interfaces 234 receive information from a user, and the output interfaces 236 output information to the user. The input interfaces 234 may include one or more of a keyboard, keypad, mouse, touchscreen, microphone, and the like. The output interfaces 236 may include one or more of a display device, touch screen, speaker, and the like.

As described herein, many functions of the WLAN device 104 may be implemented in either hardware or software. Which functions are implemented in software and which functions are implemented in hardware will vary according to constraints imposed on a design. The constraints may include one or more of design cost, manufacturing cost, time to market, power consumption, available semiconductor technology, etc.

As described herein, a wide variety of electronic devices, circuits, firmware, software, and combinations thereof may be used to implement the functions of the components of the WLAN device 104. Furthermore, the WLAN device 104 may include other components, such as application processors, storage interfaces, clock generator circuits, power supply circuits, and the like, which have been omitted in the interest of brevity.

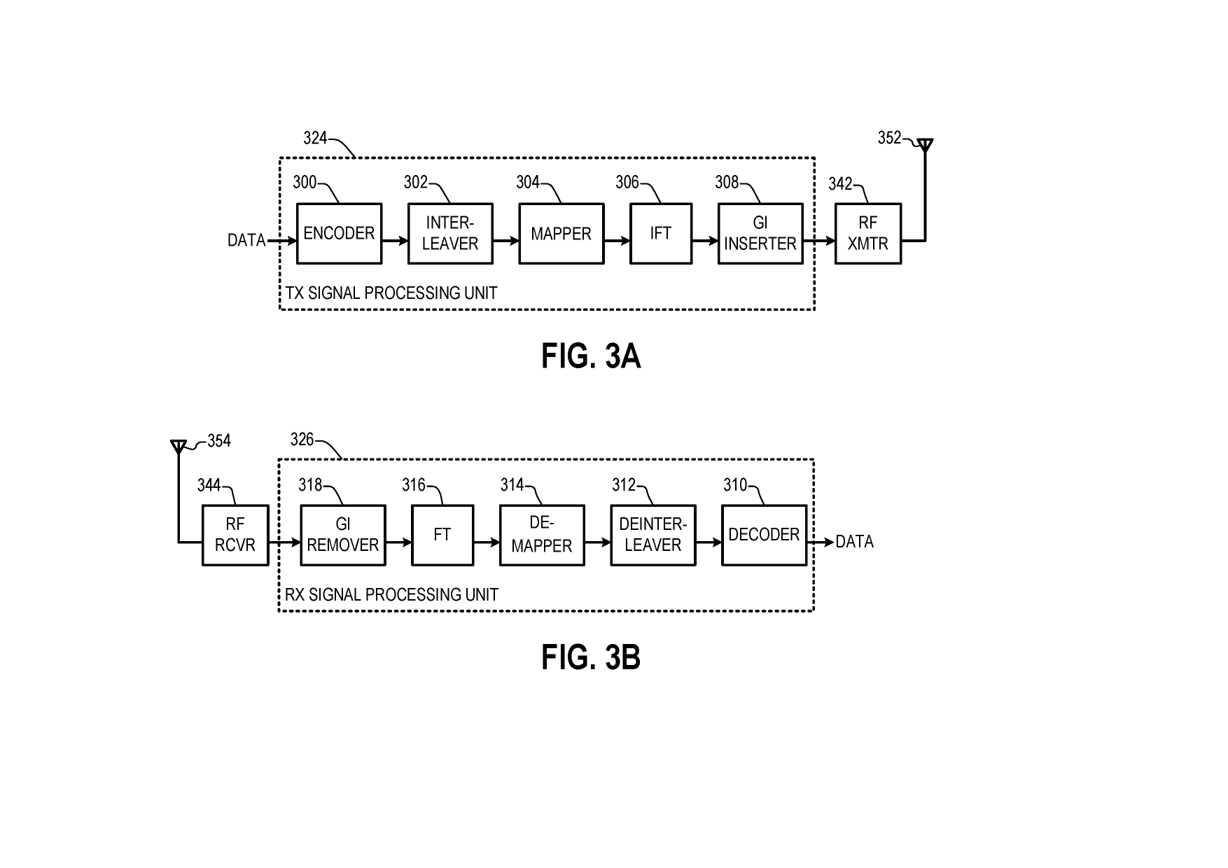

FIG. 3A illustrates components of a WLAN device 104 configured to transmit data according to an embodiment, including a transmitting (Tx) SPU (TxSP) 324, an RF transmitter 342, and an antenna 352. In an embodiment, the TxSP 324, the RF transmitter 342, and the antenna 352 correspond to the transmitting SPU 224, the RF transmitter 242, and an antenna of the antenna unit 250 of FIG. 2, respectively.

The TxSP 324 includes an encoder 300, an interleaver 302, a mapper 304, an inverse Fourier transformer (IFT) 306, and a guard interval (GI) inserter 308.

The encoder 300 receives and encodes input data. In an embodiment, the encoder 300 includes a forward error correction (FEC) encoder. The FEC encoder may include a binary convolution code (BCC) encoder followed by a puncturing device. The FEC encoder may include a low-density parity-check (LDPC) encoder.

The TxSP 324 may further include a scrambler for scrambling the input data before the encoding is performed by the encoder 300 to reduce the probability of long sequences of 0s or 1s. When the encoder 300 performs the BCC encoding, the TxSP 324 may further include an encoder parser for demultiplexing the scrambled bits among a plurality of BCC encoders. If LDPC encoding is used in the encoder, the TxSP 324 may not use the encoder parser.

The interleaver 302 interleaves the bits of each stream output from the encoder 300 to change an order of bits therein. The interleaver 302 may apply the interleaving only when the encoder 300 performs BCC encoding and otherwise may output the stream output from the encoder 300 without changing the order of the bits therein.

The mapper 304 maps the sequence of bits output from the interleaver 302 to constellation points. If the encoder 300 performed LDPC encoding, the mapper 304 may also perform LDPC tone mapping in addition to constellation mapping.

When the TxSP 324 performs a MIMO or MU-MIMO transmission, the TxSP 324 may include a plurality of interleavers 302 and a plurality of mappers 304 according to a number of spatial streams (NSS) of the transmission. The TxSP 324 may further include a stream parser for dividing the output of the encoder 300 into blocks and may respectively send the blocks to different interleavers 302 or mappers 304. The TxSP 324 may further include a space-time block code (STBC) encoder for spreading the constellation points from the spatial streams into a number of space-time streams (NSTS) and a spatial mapper for mapping the space-time streams to transmit chains. The spatial mapper may use direct mapping, spatial expansion, or beamforming.

The IFT 306 converts a block of the constellation points output from the mapper 304 (or, when MIMO or MU-MIMO is performed, the spatial mapper) to a time domain block (i.e., a symbol) by using an inverse discrete Fourier transform (IDFT) or an inverse fast Fourier transform (IFFT). If the STBC encoder and the spatial mapper are used, the IFT 306 may be provided for each transmit chain.

When the TxSP 324 performs a MIMO or MU-MIMO transmission, the TxSP 324 may insert cyclic shift diversities (CSDs) to prevent unintentional beamforming. The TxSP 324 may perform the insertion of the CSD before or after the IFT 306. The CSD may be specified per transmit chain or may be specified per space-time stream. Alternatively, the CSD may be applied as a part of the spatial mapper.

When the TxSP 324 performs a MIMO or MU-MIMO transmission, some blocks before the spatial mapper may be provided for each user.

The GI inserter 308 prepends a GI to each symbol produced by the IFT 306. Each GI may include a Cyclic Prefix (CP) corresponding to a repeated portion of the end of the symbol that the GI precedes. The TxSP 324 may optionally perform windowing to smooth edges of each symbol after inserting the GI.

The RF transmitter 342 converts the symbols into an RF signal and transmits the RF signal via the antenna 352. When the TxSP 324 performs a MIMO or MU-MIMO transmission, the GI inserter 308 and the RF transmitter 342 may be provided for each transmit chain.

FIG. 3B illustrates components of a WLAN device 104 configured to receive data according to an embodiment, including a Receiver (Rx) SPU (RxSP) 326, an RF receiver 344, and an antenna 354. In an embodiment, the RxSP 326, RF receiver 344, and antenna 354 may correspond to the receiving SPU 226, the RF receiver 244, and an antenna of the antenna unit 250 of FIG. 2, respectively.

The RxSP 326 includes a GI remover 318, a Fourier transformer (FT) 316, a demapper 314, a deinterleaver 312, and a decoder 310.

The RF receiver 344 receives an RF signal via the antenna 354 and converts the RF signal into symbols. The GI remover 318 removes the GI from each of the symbols. When the received transmission is a MIMO or MU-MIMO transmission, the RF receiver 344 and the GI remover 318 may be provided for each receive chain.

The FT 316 converts each symbol (that is, each time domain block) into a frequency domain block of constellation points by using a discrete Fourier transform (DFT) or a fast Fourier transform (FFT). The FT 316 may be provided for each receive chain.

When the received transmission is the MIMO or MU-MIMO transmission, the RxSP 326 may include a spatial demapper for converting the respective outputs of the FTs 316 of the receiver chains to constellation points of a plurality of space-time streams, and an STBC decoder for despreading the constellation points from the space-time streams into one or more spatial streams.

The demapper 314 demaps the constellation points output from the FT 316 or the STBC decoder to bit streams. If the received transmission was encoded using LDPC encoding, the demapper 314 may further perform LDPC tone demapping before performing the constellation demapping.

The deinterleaver 312 deinterleaves the bits of each stream output from the demapper 314. The deinterleaver 312 may perform the deinterleaving only when the received transmission was encoded using BCC encoding, and otherwise may output the stream output by the demapper 314 without performing deinterleaving.

When the received transmission is the MIMO or MU-MIMO transmission, the RxSP 326 may use a plurality of demappers 314 and a plurality of deinterleavers 312 corresponding to the number of spatial streams of the transmission. In this case, the RxSP 326 may further include a stream deparser for combining the streams output from the deinterleavers 312.

The decoder 310 decodes the streams output from the deinterleaver 312 or the stream deparser. In an embodiment, the decoder 310 includes an FEC decoder. The FEC decoder may include a BCC decoder or an LDPC decoder.

The RxSP 326 may further include a descrambler for descrambling the decoded data. When the decoder 310 performs BCC decoding, the RxSP 326 may further include an encoder deparser for multiplexing the data decoded by a plurality of BCC decoders. When the decoder 310 performs the LDPC decoding, the RxSP 326 may not use the encoder deparser.

Before making a transmission, wireless devices such as wireless device 104 will assess the availability of the wireless medium using Clear Channel Assessment (CCA). If the medium is occupied, CCA may determine that it is busy, while if the medium is available, CCA determines that it is idle.

The PHY entity for IEEE 802.11 is based on Orthogonal Frequency Division Multiplexing (OFDM) or Orthogonal Frequency Division Multiple Access (OFDMA). In either

OFDM or OFDMA Physical (PHY) layers, a STA (e.g., a wireless device 104) is capable of transmitting and receiving Physical Layer (PHY) Protocol Data Units (PPDUs) (also referred to as PLCP (Physical Layer Convergence Procedure) Protocol Data Units) that are compliant with the mandatory PHY specifications. A PHY specification defines a set of Modulation and Coding Schemes (MCS) and a maximum number of spatial streams. Some PHY entities define downlink (DL) and uplink (UL) Multi-User (MU) transmissions having a maximum number of space-time streams (STS) per user and employing up to a predetermined total number of STSs. A PHY entity may provide support for 10 Megahertz (MHz), 20 MHz, 40 MHz, 80 MHz, 160 MHz, 240 MHz, and 320 MHz contiguous channel widths and support for an 80+80, 80+160 MHz, and 160+160 MHz non-contiguous channel width. Each channel includes a plurality of subcarriers, which may also be referred to as tones. A PHY entity may define signaling fields denoted as Legacy Signal (L-SIG), Signal A (SIG-A), and Signal B (SIG-B), and the like within a PPDU by which some necessary information about PHY Service Data Unit (PSDU) attributes are communicated. The descriptions below, for sake of completeness and brevity, refer to OFDM-based 802.11 technology. Unless otherwise indicated, a station refers to a non-AP STA.

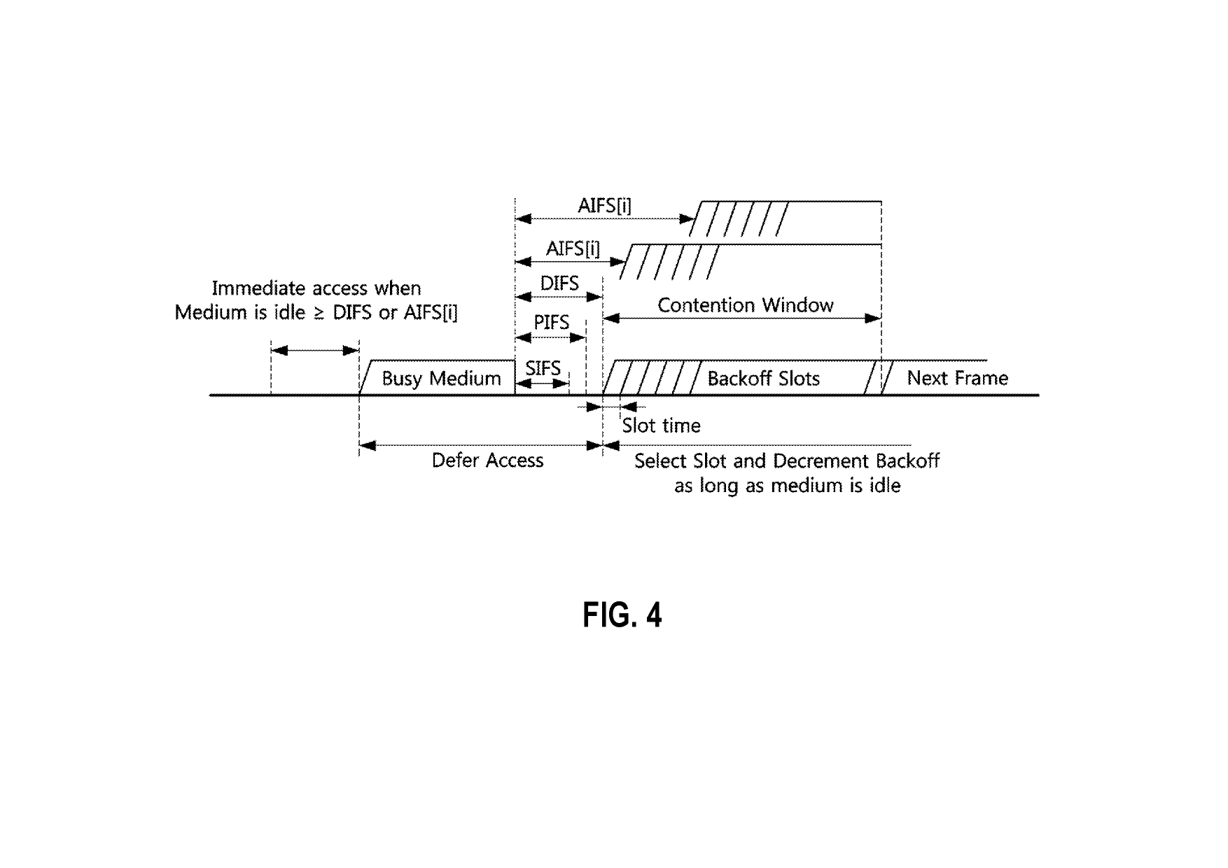

FIG. 4 illustrates Inter-Frame Space (IFS) relationships. In particular, FIG. 4 illustrates a Short IFS (SIFS), a Point Coordination Function (PCF) IFS (PIFS), a Distributed Coordination Function (DCF) IFS (DIFS), and an Arbitration IFSs corresponding to an Access Category (AC) ‘i’ (AIFS[i]). FIG. 4 also illustrates a slot time and a data frame is used for transmission of data forwarded to a higher layer. As shown, a WLAN device 104 transmits the data frame after performing backoff if a DIFS has elapsed during which the medium has been idle.

A management frame may be used for exchanging management information, which is not forwarded to the higher layer. Subtype frames of the management frame include a beacon frame, an association request/response frame, a probe request/response frame, and an authentication request/response frame.

A control frame may be used for controlling access to the medium. Subtype frames of the control frame include a request to send (RTS) frame, a clear to send (CTS) frame, and an acknowledgement (ACK) frame.

When the control frame is not a response frame of another frame, the WLAN device 104 transmits the control frame after performing backoff if a DIFS has elapsed during which the medium has been idle. When the control frame is the response frame of another frame, the WLAN device 104 transmits the control frame after a SIFS has elapsed without performing backoff or checking whether the medium is idle.

A WLAN device 104 that supports Quality of Service (QoS) functionality (that is, a QoS STA) may transmit the frame after performing backoff if an AIFS for an associated access category (AC) (i.e., AIFS[AC]) has elapsed. When transmitted by the QoS STA, any of the data frame, the management frame, and the control frame, which is not the response frame, may use the AIFS[AC] of the AC of the transmitted frame.

A WLAN device 104 may perform a backoff procedure when the WLAN device 104 that is ready to transfer a frame finds the medium busy. The backoff procedure includes determining a random backoff time composed of N backoff slots, where each backoff slot has a duration equal to a slot time and N being an integer number greater than or equal to zero. The backoff time may be determined according to a length of a Contention Window (CW). In an embodiment, the backoff time may be determined according to an AC of the frame. All backoff slots occur following a DIFS or Extended IFS (EIFS) period during which the medium is determined to be idle for the duration of the period.

When the WLAN device 104 detects no medium activity for the duration of a particular backoff slot, the backoff procedure shall decrement the backoff time by the slot time. When the WLAN device 104 determines that the medium is busy during a backoff slot, the backoff procedure is suspended until the medium is again determined to be idle for the duration of a DIFS or EIFS period. The WLAN device 104 may perform transmission or retransmission of the frame when the backoff timer reaches zero.

The backoff procedure operates so that when multiple WLAN devices 104 are deferring and execute the backoff procedure, each WLAN device 104 may select a backoff time using a random function and the WLAN device 104 that selects the smallest backoff time may win the contention, reducing the probability of a collision.

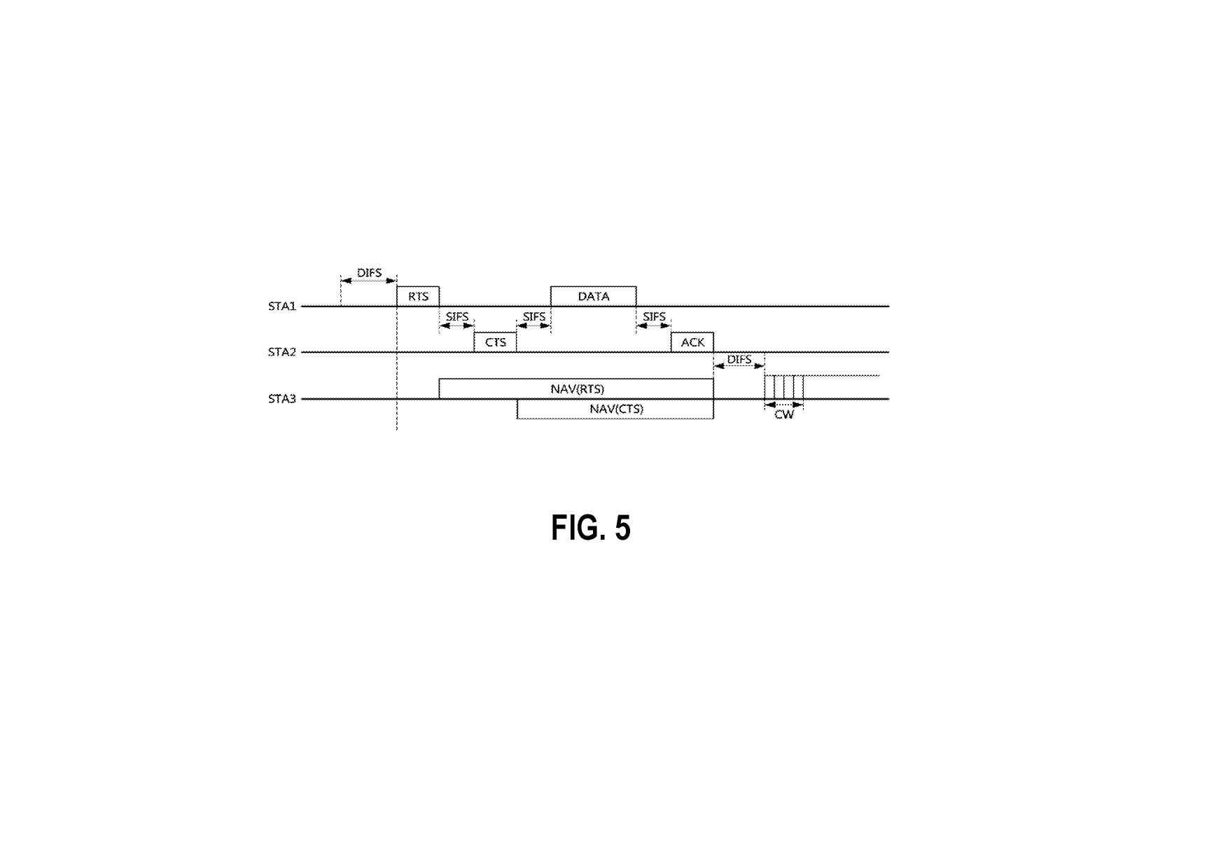

FIG. 5 illustrates a Carrier Sense Multiple Access/Collision Avoidance (CSMA/CA) based frame transmission procedure for avoiding collision between frames in a channel according to an embodiment. FIG. 5 shows a first station STA1 transmitting data, a second station STA2 receiving the data, and a third station STA3 that may be located in an area where a frame transmitted from the STA1 can be received, a frame transmitted from the second station STA2 can be received, or both can be received. The stations STA1, STA2, and STA3 may be WLAN devices 104 of FIG. 1.

The station STA1 may determine whether the channel is busy by carrier sensing. The station STA1 may determine channel occupation/status based on an energy level in the channel or an autocorrelation of signals in the channel, or may determine the channel occupation by using a network allocation vector (NAV) timer.

After determining that the channel is not used by other devices (that is, that the channel is IDLE) during a DIFS (and performing backoff if required), the station STA1 may transmit a Request-To-Send (RTS) frame to the station STA2. Upon receiving the RTS frame, after a SIFS the station STA2 may transmit a Clear-To-Send (CTS) frame as a response to the RTS frame. If Dual-CTS is enabled and the station STA2 is an AP, the AP may send two CTS frames in response to the RTS frame (e.g., a first CTS frame in a non-High Throughput format and a second CTS frame in the HT format).

When the station STA3 receives the RTS frame, it may set a NAV timer of the station STA3 for a transmission duration of subsequently transmitted frames (for example, a duration of SIFS + CTS frame duration + SIFS + data frame duration + SIFS + ACK frame duration) using duration information included in the RTS frame. When the station STA3 receives the CTS frame, it may set the NAV timer of the station STA3 for a transmission duration of subsequently transmitted frames using duration information included in the CTS frame. Upon receiving a new frame before the NAV timer expires, the station STA3 may update the NAV timer of the station STA3 by using duration information included in the new frame. The station STA3 does not attempt to access the channel until the NAV timer expires.

When the station STA1 receives the CTS frame from the station STA2, it may transmit a data frame to the station STA2 after a SIFS period elapses from a time when the CTS frame has been completely received. Upon successfully receiving the data frame, the station STA2 may transmit an ACK frame as a response to the data frame after a SIFS period elapses.

When the NAV timer expires, the third station STA3 may determine whether the channel is busy using the carrier sensing. Upon determining that the channel is not used by other devices during a DIFS period after the NAV timer has expired, the station STA3 may attempt to access the channel after a contention window elapses according to a backoff process.

When Dual-CTS is enabled, a station that has obtained a transmission opportunity (TXOP) and that has no data to transmit may transmit a CF-End frame to cut short the TXOP. An AP receiving a CF-End frame having a Basic Service Set Identifier (BSSID) of the AP as a destination address may respond by transmitting two more CF-End frames: a first CF-End frame using Space Time Block Coding (STBC) and a second CF-End frame using non-STBC. A station receiving a CF-End frame resets its NAV timer to 0 at the end of the PPDU containing the CF-End frame. FIG. 5 shows the station STA2 transmitting an ACK frame to acknowledge the successful reception of a frame by the recipient.

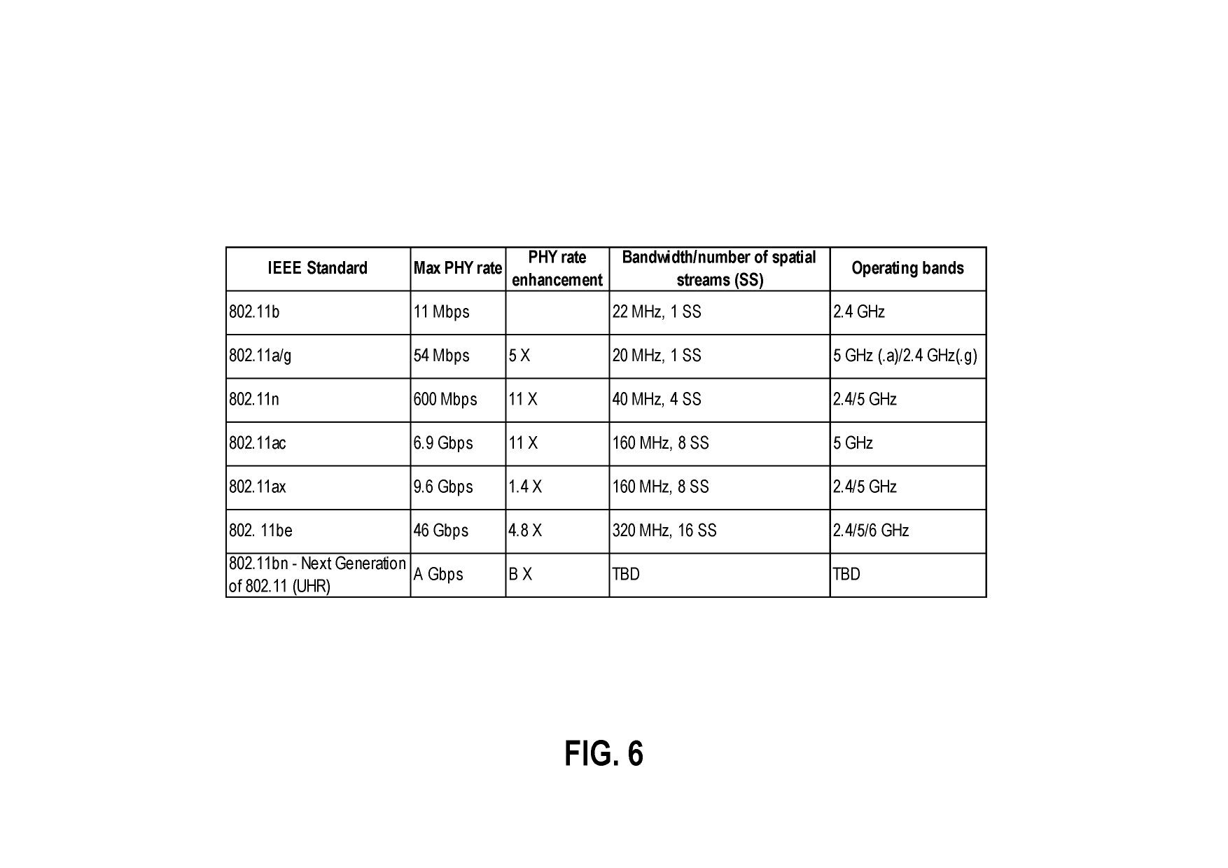

The IEEE 802.11bn (Ultra High Reliability, UHR) working group has been established to address the growing demand for higher peak throughput and reliability in Wi-Fi. As shown in FIG. 6, the peak PHY rate has significantly increased from IEEE 802.11b to IEEE 802.11be (Wi-Fi 7), with the latter focusing on further improving peak throughput. The UHR study group aims to enhance the tail of the latency distribution and jitter to support applications that require low latency, such as video-over-WLAN, gaming, AR, and VR. It is noted that various characteristics of UHR (e.g., max PHY rate, PHY rate enhancement, bandwidth/number of spatial streams, and operating bands) are still to be determined.

The focus of IEEE 802.11be is primarily on WLAN indoor and outdoor operation with stationary and pedestrian speeds in the 2.4, 5, and 6 GHz frequency bands. In addition to peak PHY rate, different candidate features are under discussion. These candidate features include (1) a 320MHz bandwidth and a more efficient utilization of a non-contiguous spectrum, (2) multi-band/multi-channel aggregation and operation, (3) 16 spatial streams and Multiple Input Multiple Output (MIMO) protocol enhancements, (4) multi-Access Point (AP) Coordination (e.g., coordinated and joint transmission), (5) an enhanced link adaptation and retransmission protocol (e.g., Hybrid Automatic Repeat Request (HARQ)), and (6) adaptation to regulatory rules specific to a 6 GHz spectrum.

The focus of IEEE 802.11bn (UHR) is still under discussion, with candidate features including MLO enhancements (e.g., in terms of increased throughput/reliability and decreased latency), latency and reliability improvements (e.g., multi-AP coordination to support low latency traffic), bandwidth expansion (e.g., to 240, 480, 640 MHz), aggregated PPDU (A-PPDU), enhanced multi-link single-radio (eMLSR) extensions to AP, roaming improvements, and power-saving schemes for prolonging battery life.

Some features, such as increasing the bandwidth and the number of spatial streams, are solutions that have been proven to be effective in previous projects focused on increasing link throughput and on which feasibility demonstration is achievable.

With respect to operational bands (e.g., 2.4/5/6 GHz) for IEEE 802.11be, more than 1 GHz of additional unlicensed spectrum is likely to be available because the 6 GHz band (5.925– 7.125 GHz) is being considered for unlicensed use. This would allow APs and STAs to become tri-band devices. Larger than 160MHz data transmissions (e.g., 320 MHz or 640 MHz) could be considered to increase the maximum PHY rate. For example, 320 MHz or 160+160MHz data could be transmitted in the 6 GHz band. For example, 160+160 MHz data could be transmitted across the 5 and 6 GHz bands.

In the process of wireless communication, a transmitting station (STA) creates a Physical Layer Protocol Data Unit (PPDU) frame and sends it to a receiving STA. The receiving STA then receives, detects, and processes the PPDU.

The Extremely High Throughput (EHT) PPDU frame encompasses several components. It includes a legacy part, which comprises fields such as the Legacy Short Training Field (L-STF), Legacy Long Training Field (L-LTF), Legacy Signal Field (L-SIG), and Repeated Legacy Signal Field (RL-SIG). These fields are used to maintain compatibility with older Wi-Fi standards.

In addition to the legacy part, the EHT PPDU frame also contains the Universal Signal Field (U-SIG), EHT Signal Field (EHT-SIG), EHT Short Training Field (EHT-STF), and EHT Long Training Field (EHT-LTF). These fields are specific to the EHT standard and are used for various purposes, such as signaling, synchronization, and channel estimation.

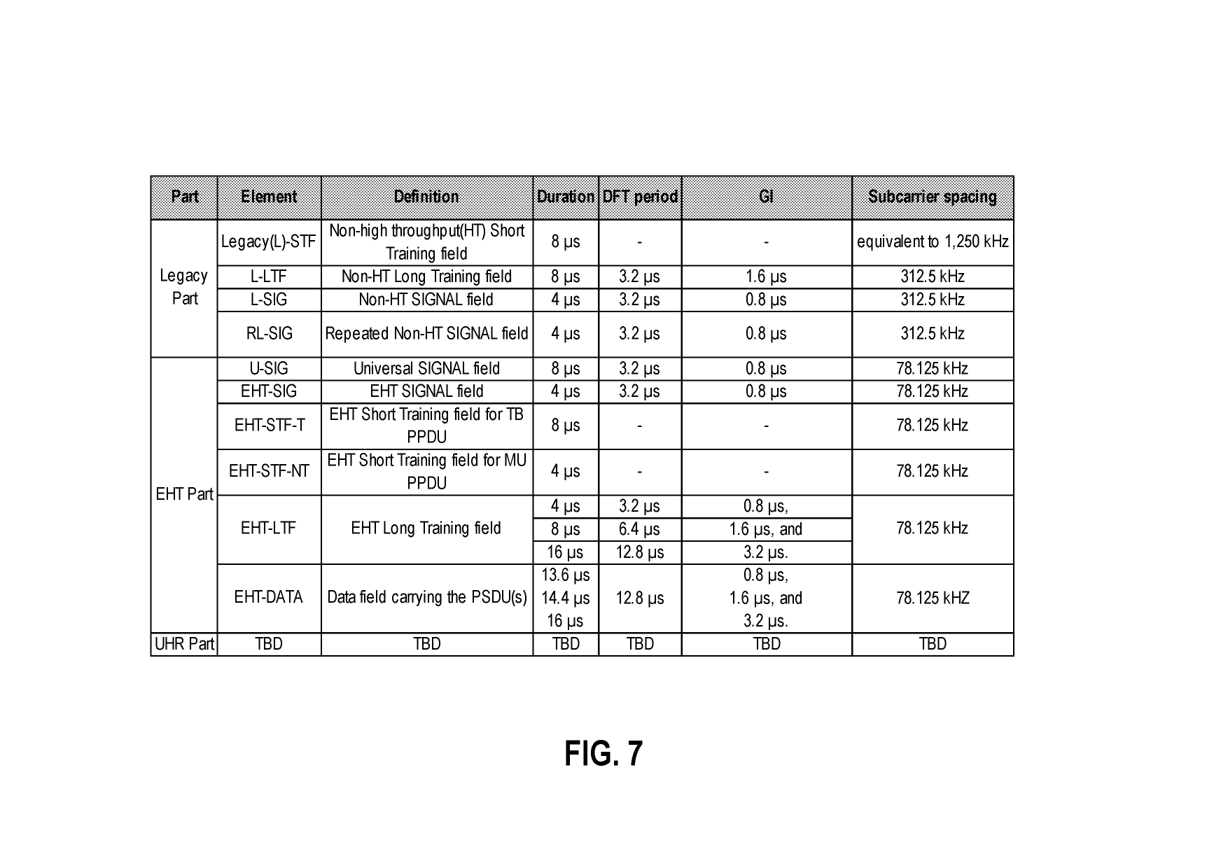

FIG. 7 provides a more detailed description of each field in the EHT PPDU frame, including their purposes and characteristics.

Regarding the Ultra High Reliability (UHR) PPDU, its frame structure is currently undefined and will be determined through further discussions within the relevant working group or study group. This indicates that the specifics of the UHR PPDU are still under development and will be finalized based on the outcomes of future deliberations.

The distributed nature of channel access networks, such as IEEE 802.11 WLANs, makes the carrier sense mechanism useful for ensuring collision-free operation. Each station (STA) uses its physical carrier sense to detect transmissions from other STAs. However, in certain situations, it may not be possible for a STA to detect every transmission. For instance, when one STA is located far away from another STA, it might perceive the medium as idle and start transmitting a frame, leading to collisions. To mitigate this hidden node problem, the network allocation vector (NAV) has been introduced.

As the IEEE 802.11 standard continues to evolve, it now includes scenarios where multiple users can simultaneously transmit or receive data within a basic service set (BSS), such as uplink (UL) and downlink (DL) multi-user (MU) transmissions in a cascaded manner. In these cases, the existing carrier sense and NAV mechanisms may not be sufficient, and modifications or newly defined mechanisms may be required to facilitate efficient and collision-free operation.

For the purpose of this disclosure, MU transmission refers to situations where multiple frames are transmitted to or from multiple STAs simultaneously using different resources. Examples of these resources include different frequency resources in Orthogonal Frequency Division Multiple Access (OFDMA) transmission and different spatial streams in Multi-User Multiple Input Multiple Output (MU-MIMO) transmission. Consequently, downlink OFDMA (DL-OFDMA), downlink MU-MIMO (DL-MU-MIMO), uplink OFDMA (UL- OFDMA), uplink MU-MIMO (UL-MU-MIMO), and OFDMA with MU-MIMO are all considered examples of MU transmission.

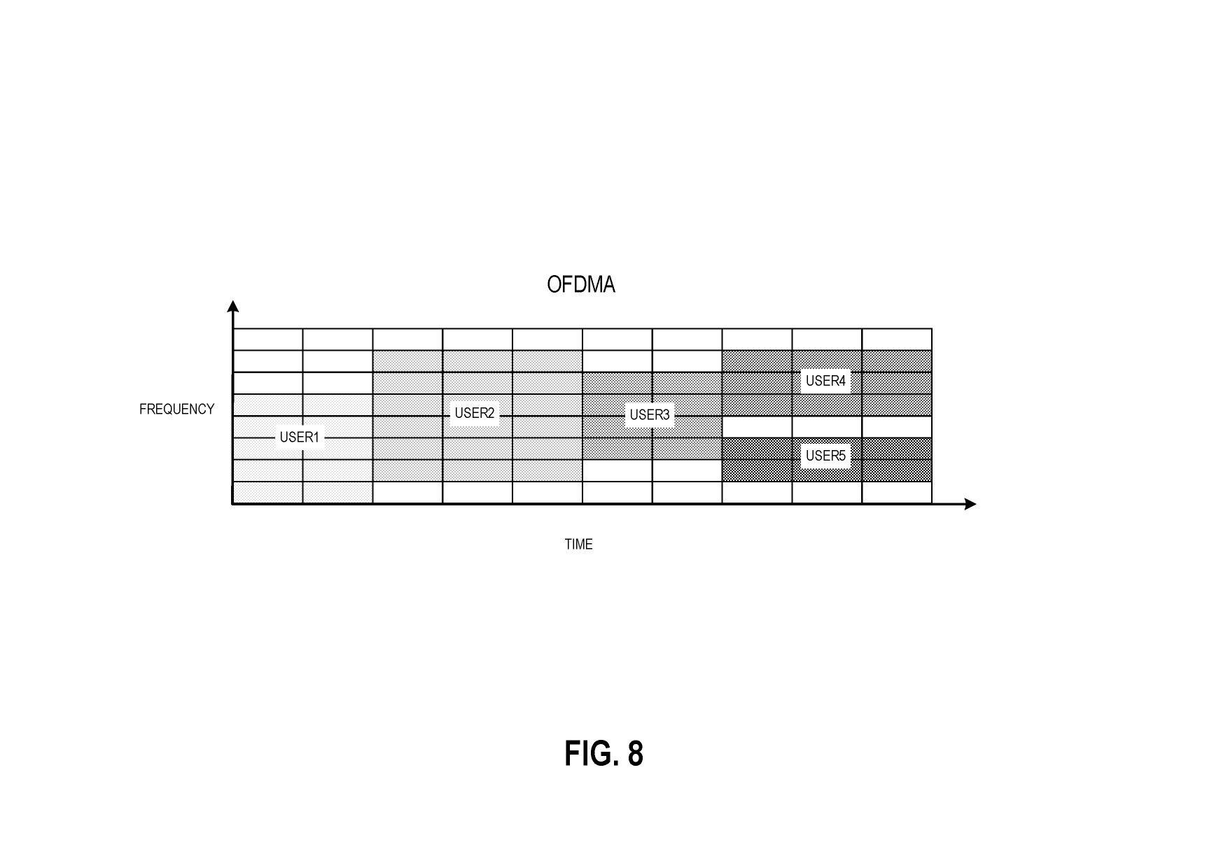

FIG. 8 illustrates an example of multi-user (MU) transmission in Orthogonal Frequency-Division Multiple Access (OFDMA), in accordance with some embodiments of the present disclosure.

In the IEEE 802.11ax and 802.11be specifications, the trigger frame plays a useful role in facilitating uplink multi-user (MU) transmissions. The purpose of the trigger frame is to allocate resources and solicit one or more Trigger-based (TB) Physical Layer Protocol Data Unit (PPDU) transmissions from the associated stations (STAs).

The trigger frame contains information required by the responding STAs to send their Uplink TB PPDUs. This information includes the Trigger type, which specifies the type of TB PPDU expected, and the Uplink Length (UL Length), which indicates the duration of the uplink transmission.

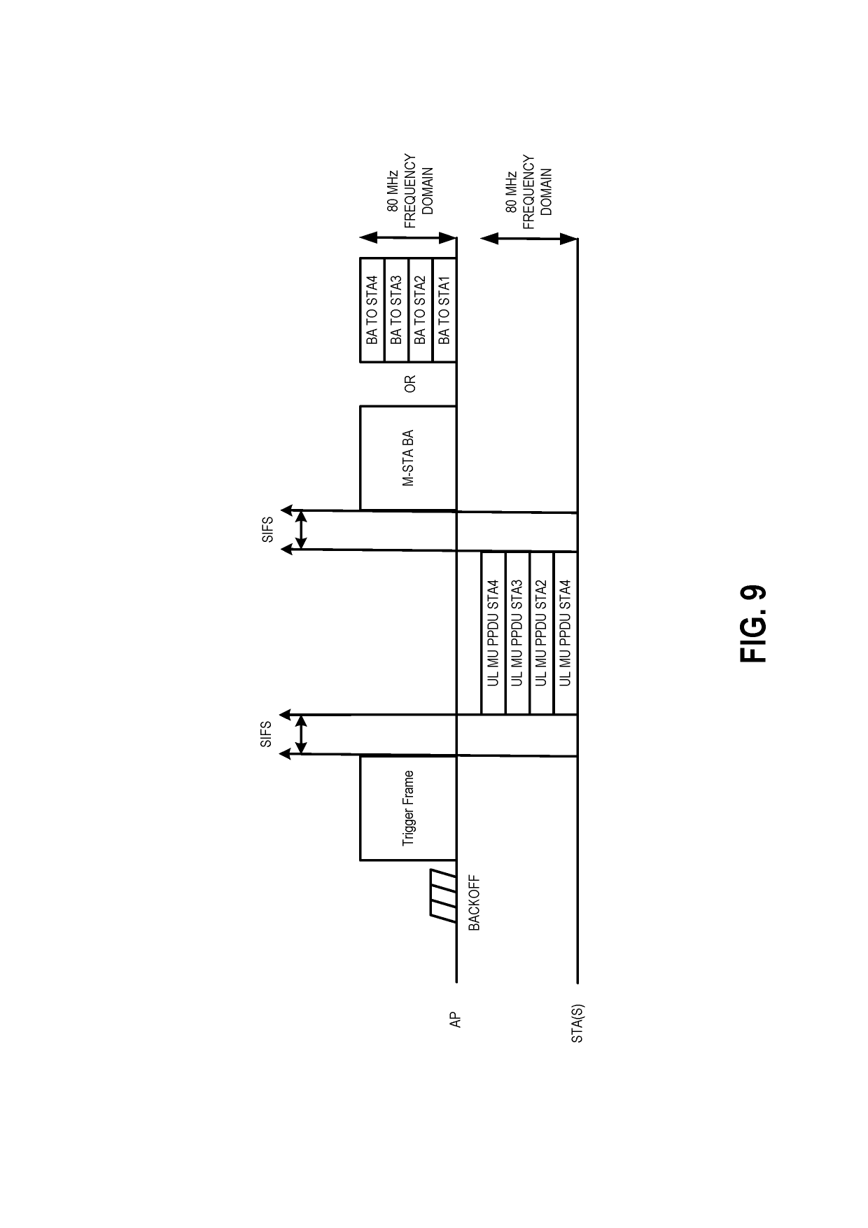

FIG. 9 illustrates an example scenario where an access point (AP) operating in an 80MHz bandwidth environment sends a Trigger frame to multiple associated STAs. Upon receiving the Trigger frame, the STAs respond by sending their respective Uplink Orthogonal Frequency Division Multiple Access (UL OFDMA) TB PPDUs, utilizing the allocated resources within the specified 80 MHz bandwidth.

After successfully receiving the UL OFDMA TB PPDUs, the AP acknowledges the STAs by sending an acknowledgement frame. This acknowledgement can be in the form of an 80MHz width multi-STA Block Acknowledgement (Block Ack) or a Block Acknowledgement with a Direct Feedback (DF) OFDMA method. The multi-STA Block Ack allows the AP to acknowledge multiple STAs simultaneously, while the Block Ack with DF OFDMA enables the AP to provide feedback to the STAs using the same OFDMA technique employed in the uplink transmission.

The trigger frame is a useful component in enabling efficient uplink MU transmissions in IEEE 802.11ax and 802.11be networks, by allocating resources and coordinating the uplink transmissions from multiple STAs within the same bandwidth.

Wireless network systems can rely on retransmission of media access control (MAC) protocol data units (MPDUs) when the transmitter (TX) does not receive an acknowledgement from the receiver (RX) or MPDUs are not successfully decoded by the receiver. Using an automatic repeat request (ARQ) approach, the receiver discards the last failed MPDU before receiving the newly retransmitted MPDU. With requirements of enhanced reliability and reduced latency, the wireless network system can evolve toward a hybrid ARQ (HARQ) approach.

There are two methods of HARQ processing. In a first type of HARQ scheme, also referred to as chase combining (CC) HARQ (CC-HARQ) scheme, signals to be retransmitted are the same as the signals that previously failed because all subpackets to be retransmitted use the same puncturing pattern. The puncturing is needed to remove some of the parity bits after encoding using an error-correction code. The reason why the same puncturing pattern is used with CC-HARQ is to generate a coded data sequence with forward error correction (FEC) and to make the receiver use a maximum-ratio combining (MRC) to combine the received, retransmitted bits with the same bits from the previous transmission. For example, information sequences are transmitted in packets with a fixed length. At a receiver, error correction and detection are carried out over the whole packet. However, the ARQ scheme may be inefficient in the presence of burst errors. To solve this more efficiently, subpackets are used. In subpacket transmissions, only those subpackets that include errors need to be retransmitted.

Since the receiver uses both the current and the previously received subpackets for decoding data, the error probability in decoding decreases as the number of used subpackets increases. The decoding process passes a cyclic redundancy check (CRC) and ends when the entire packet is decoded without error or the maximum number of subpackets is reached. In particular, this scheme operates on a stop-and-wait protocol such that if the receiver can decode the packet, it sends an acknowledgement (ACK) to the transmitter. When the transmitter receives an ACK successfully, it terminates the HARQ transmission of the packet. If the receiver cannot decode the packet, it sends a negative acknowledgement (NAK) to the transmitter and the transmitter performs the retransmission process.

In a second type of HARQ scheme, also referred to as an incremental redundancy (IR) HARQ (IR-HARQ) scheme, different puncturing patterns are used for each subpacket such that the signal changes for each retransmitted subpacket in comparison to the originally transmitted subpacket. IR-HARQ alternatively uses two puncturing patterns for odd numbered and even numbered transmissions, respectively. The redundancy scheme of IR-HARQ improves the log likelihood ratio (LLR) of parity bit(s) in order to combine information sent across different transmissions due to requests and lowers the code rate as the additional subpacket is used. This results in a lower error rate of the subpacket in comparison to CC-HARQ. The puncturing pattern used in IR-HARQ is indicated by a subpacket identity (SPID) indication. The SPID of the first subpacket may always be set to 0 and all the systematic bits and the punctured parity bits are transmitted in the first subpacket. Self-decoding is possible when the receiving signal- to-noise ratio (SNR) environment is good (i.e., a high SNR). In some embodiments, subpackets with corresponding SPIDs to be transmitted are in increasing order of SPID but can be exchanged/switched except for the first SPID.

AP coordination has been considered as a potential technology to improve WLAN system throughput in the IEEE 802.11be standard and is still being discussed in the IEEE 802.11bn (UHR) standard. To support various AP coordination schemes, such as coordinated beamforming, OFDMA, TDMA, spatial reuse, and joint transmission, a predefined mechanism for APs is necessary.

In the context of coordinated TDMA (C-TDMA), the AP that obtains a transmit opportunity (TXOP) is referred to as the sharing AP. This AP initiates the AP coordination schemes to determine the AP candidate set by sending a frame, such as a Beacon frame or probe response frame, which includes information about the AP coordination scheme capabilities. The AP that participates in the AP coordination schemes after receiving the frame from the sharing AP is called the shared AP. The sharing AP is also known as the master AP or coordinating AP, while the shared AP is referred to as the slave AP or coordinated AP.

The operation of various AP coordination schemes has been discussed in the IEEE 802.11be and UHR standards:

Coordinated Beamforming (C-BF): Multiple APs transmit on the same frequency resource by coordinating and forming spatial nulls, allowing for simultaneous transmission from multiple APs.

Coordinated OFDMA (C-OFDMA): APs transmit on orthogonal frequency resources by coordinating and splitting the spectrum, enabling more efficient spectrum utilization.

Joint Transmission (JTX): Multiple APs transmit jointly to a given user simultaneously by sharing data between the APs.

Coordinated Spatial Reuse (C-SR): Multiple APs or STAs adjust their transmit power to reduce interference between APs.

By implementing these AP coordination schemes, WLAN systems can improve their overall throughput and efficiency by leveraging the cooperation between multiple APs.

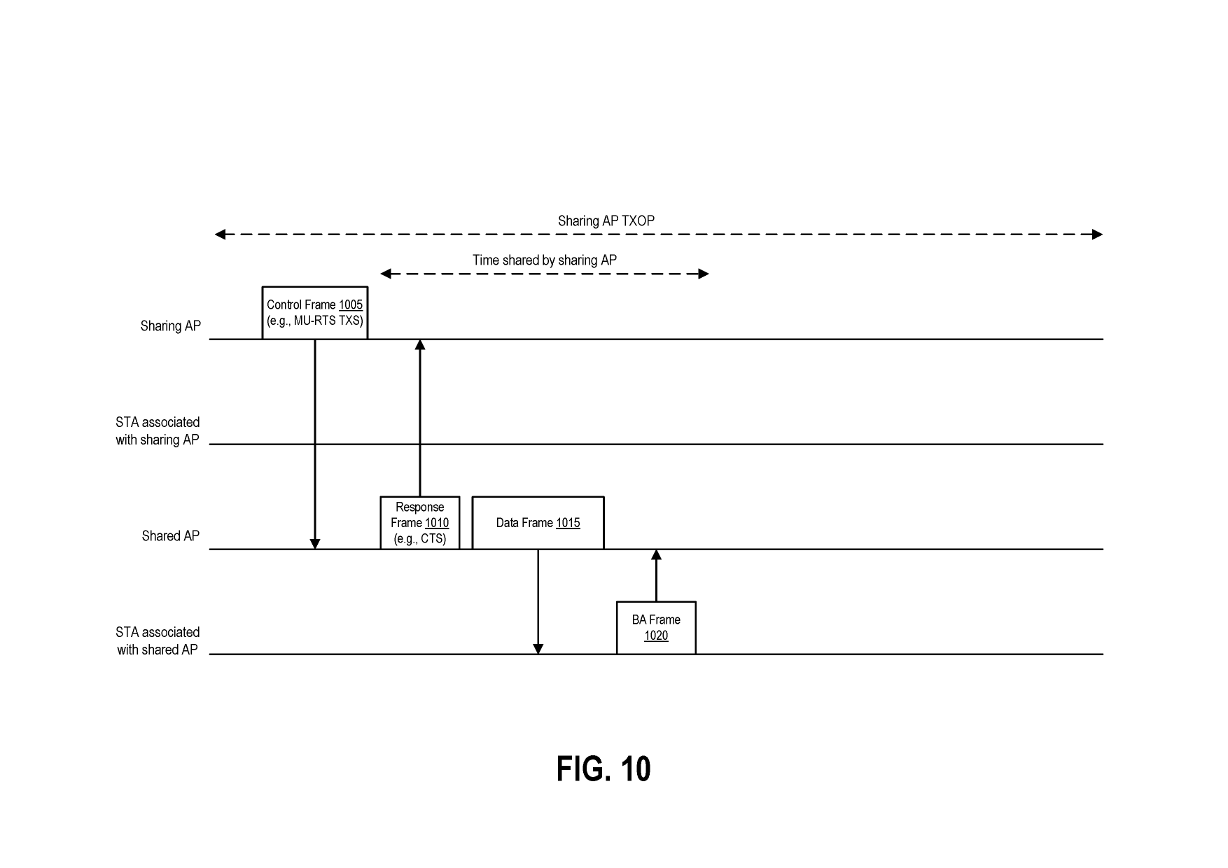

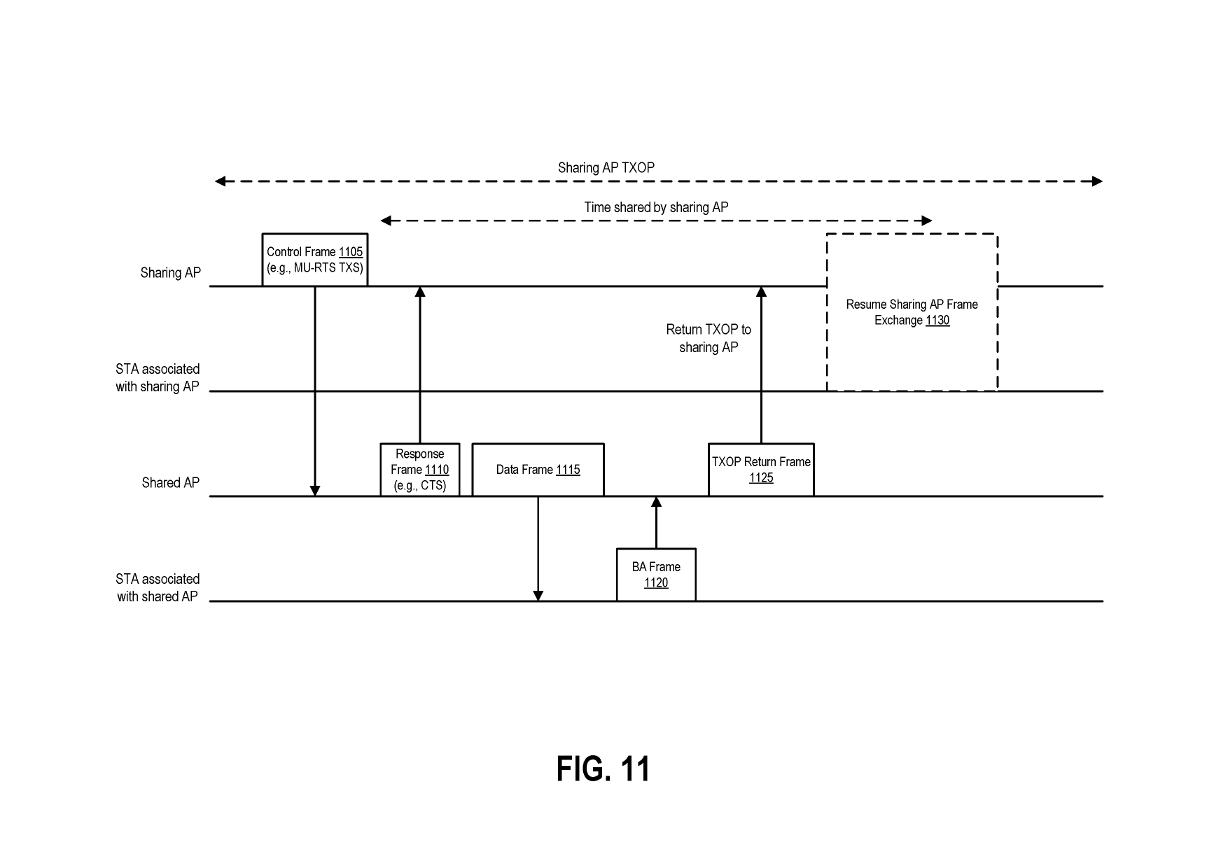

In a c-TDMA scenario, TXOP return may be allowed or not allowed. FIG. 10 shows a c-TDMA scenario where TXOP return is not allowed and FIG. 11 shows a c-TDMA scenario where TXOP return is allowed.

FIG. 10 is a diagram showing a c-TDMA scenario where TXOP return is not allowed and the shared AP uses all of its allocated portion of the TXOP, according to some embodiments.

As shown in the diagram, the sharing AP may transmit control frame 1005 to the shared AP to indicate to the shared AP that the sharing AP is allocating a portion of the sharing AP’s TXOP to the shared AP. In an embodiment, control frame 1005 is a multi-user request-to-send TXOP sharing (MU-RTS TXS) frame. Responsive to receiving control frame 1005, the shared AP may transmit response frame 1010 to the sharing AP. In an embodiment, response frame 1010 is a CTS frame. During the portion of the sharing AP’s TXOP allocated to the shared AP (depicted as “Time shared by sharing AP” in the diagram), the shared AP may transmit data frame 1015 to a STA that is associated with the shared AP. If the STA successfully receives data frame 1015, the STA may transmit block acknowledgement (BA) frame 1020 to the shared AP. The sharing AP may resume its TXOP (e.g., resume transmission and reception with its associated non-AP STAs) after the portion of the TXOP allocated to the shared AP expires.

FIG. 11 is a diagram showing a c-TDMA scenario where TXOP return is allowed and the sharing AP resumes the TXOP after receiving a TXOP return frame from the shared AP, according to some embodiments.

The diagram illustrates a c-TDMA scenario where the sharing AP allocates a portion of its TXOP to the shared AP and allows the TXOP to be returned. If the shared AP completes its transmission and reception before the allocated portion of the TXOP expires, the shared AP may return the TXOP to the sharing AP, which allows the sharing AP to resume the TXOP and continue transmission and reception with its associated non-AP STAs.

As shown in the diagram, the sharing AP may transmit control frame 1105 (e.g., MU-RTS TXS frame) to the shared AP to indicate to the shared AP that the sharing AP is allocating a portion of the sharing AP’s TXOP to the shared AP. Responsive to receiving control frame 1105, the shared AP may transmit response frame 1110 (e.g., CTS frame) to the sharing AP. During the portion of the sharing AP’s TXOP allocated to the shared AP (depicted as “Time shared by sharing AP” in the diagram), the shared AP may transmit data frame 1115 to a STA that is associated with the shared AP. If the STA successfully receives data frame 1115, the STA may transmit BA frame 1120 to the shared AP. If the shared AP finishes transmission reception in its BSS before its allocated portion of the TXOP expires, the shared AP may transmit TXOP return frame 1125 to the sharing AP to return the TXOP to the sharing AP. Upon receiving TXOP return frame 1125, the sharing AP may resume the TXOP. For example, the sharing AP may perform frame exchange 1130 in its own BSS with its associated non-AP STAs.

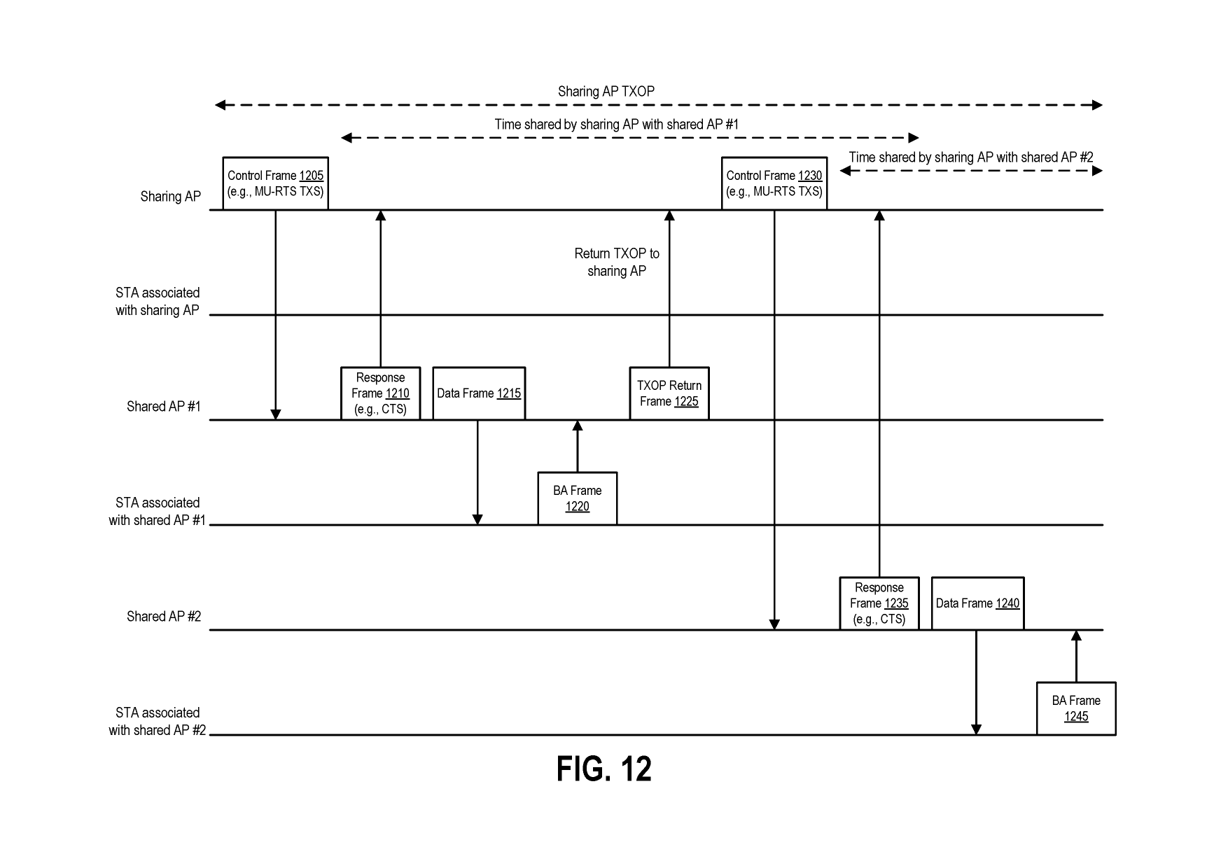

FIG. 12 is a diagram showing a c-TDMA scenario where TXOP return is allowed and the sharing AP shares its TXOP with multiple APs in succession, according to some embodiments.

The diagram illustrates a c-TDMA scenario where the sharing AP allocates a portion of its TXOP to the shared AP and requests TXOP return. If the shared AP completes its transmission and reception before its allocated portion of the TXOP expires, the shared AP may return the TXOP to the sharing AP, which allows the sharing AP to resume the TXOP. After resuming the TXOP, the sharing AP may allocate another portion of its TXOP to another shared AP.

As shown in the diagram, the sharing AP may transmit control frame 1205 (e.g., MU-RTS TXS frame) to shared AP #1 to indicate to shared AP #1 that the sharing AP is allocating a portion of the sharing AP’s TXOP to shared AP #1. Responsive to receiving control frame 1205, shared AP #1 may transmit response frame 1210 (e.g., CTS frame) to the sharing AP. During the portion of the sharing AP’s TXOP allocated to shared AP #1 (depicted as “Time shared by sharing AP with shared AP #1” in the diagram), shared AP #1 may transmit data frame 1215 to a STA that is associated with shared AP #1. If the STA successfully receives data frame 1215, the STA may transmit BA frame 1220 to shared AP #1. If shared AP #1 finishes transmission and reception in its BSS before the allocated portion of the TXOP expires, shared AP #1 may transmit TXOP return frame 1225 to the sharing AP to return the TXOP to the sharing AP. Upon receiving TXOP return frame 1225, the sharing AP may resume the TXOP. The sharing AP may then transmit control frame 1230 (e.g., MU-RTS TXS frame) to shared AP #2 to indicate to shared AP #2 that the sharing AP is allocating a portion of the sharing AP’s TXOP to shared AP #2. Responsive to receiving control frame 1230, shared AP #2 may transmit response frame 1235 (e.g., CTS frame) to the sharing AP. During the portion of the sharing AP’s TXOP allocated to shared AP #2 (depicted as “Time shared by sharing AP with shared AP #2” in the diagram), shared AP #2 may transmit data frame 1240 to a STA that is associated with shared AP #2. If the STA successfully receives data frame 1240, the STA may transmit BA frame 1245 to shared AP #2.

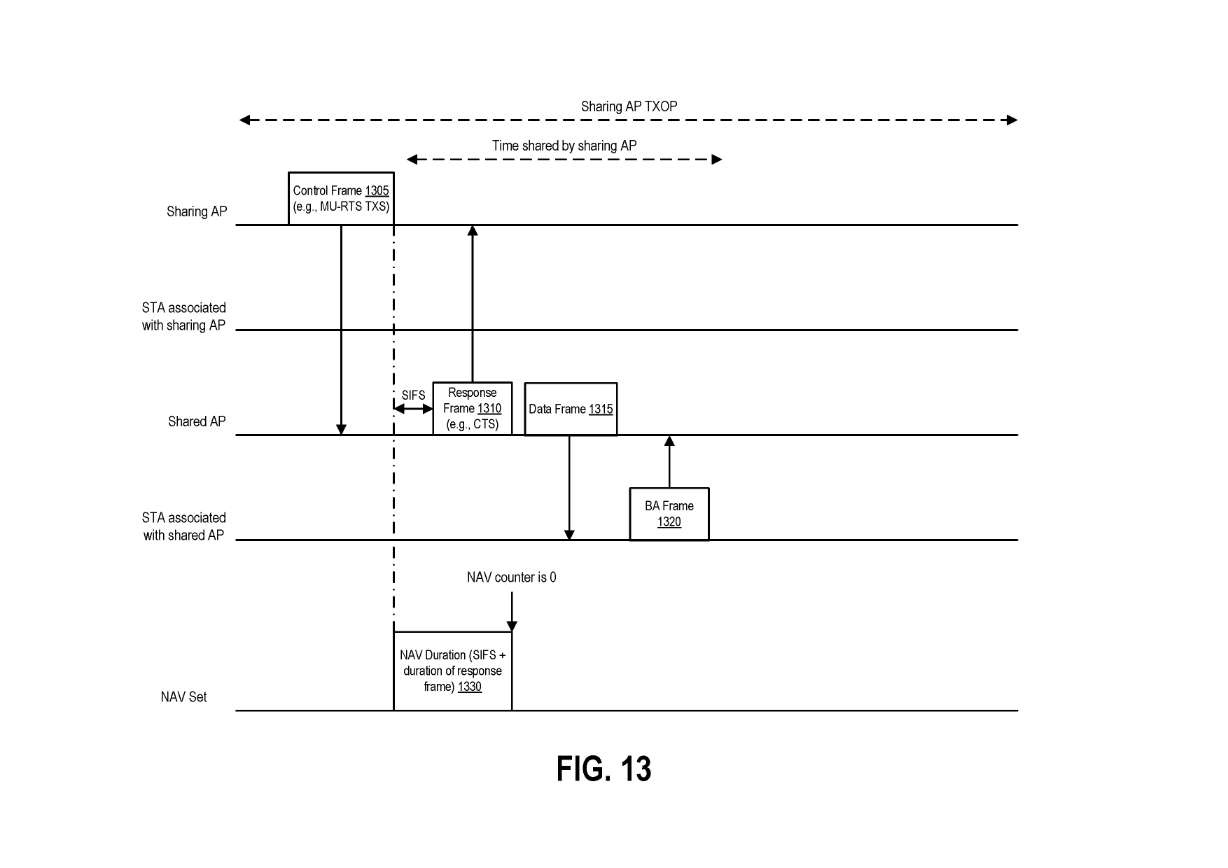

FIG. 13 is a diagram showing a duration/ID field included in the MU-RTS TXS frame being set to the sum of a CTS frame transmission duration and one SIFS interval duration, according to some embodiments.

The diagram illustrates the NAV duration in a c-TDMA scenario where the sharing AP allocates a portion of its TXOP to the shared AP using a control frame exchange (e.g., MU-RTS TXS frame and CTS frame exchange).

As shown in the diagram, the sharing AP may transmit control frame 1305 (e.g., MU-RTS TXS frame) to the shared AP to indicate to the shared AP that the sharing AP is allocating a portion of the sharing AP’s TXOP to the shared AP. Responsive to receiving control frame 1305, the shared AP may transmit response frame 1310 (e.g., CTS frame) to the sharing AP after a short interframe space (SIFS) interval after receiving control frame 1305. During the portion of the sharing AP’s TXOP allocated to the shared AP (depicted as “Time shared by sharing AP” in the diagram), the shared AP may transmit data frame 1315 to a STA that is associated with the shared AP. If the STA successfully receives data frame 1315, the STA may transmit BA frame 1320 to the shared AP.

Control frame 1305 may set a NAV duration 1330 that corresponds to the sum of the transmission duration of response frame 1310 and a SIFS interval duration. For example, if control frame 1305 is a MU-RTS TXS frame and response frame 1310 is a CTS frame, the duration/ID field included in the MU-RTS TXS frame may be set to indicate the duration required to transmit the CTS frame plus the duration of one SIFS interval.

In the scenarios shown in FIGS. 10-13, the sharing AP is depicted as transmitting the MU-RTS TXS frame (e.g., control frame 1005) in the middle of its TXOP instead of at the beginning of its TXOP. The reason for this is that, prior to transmitting the MU-RTS TXS frame to share its TXOP, the sharing AP may perform a process to select the AP(s) that are to be allocated a portion of the sharing AP’s TXOP. Also, prior to transmitting the MU-RTS TXS frame, the sharing AP may perform frame exchanges with non-AP STAs associated with the sharing AP.

During a polling phase (prior to allocating a portion of its TXOP to a shared AP), the sharing AP may transmit an initial control frame to candidate shared AP(s). The candidate shared AP(s) may be candidate(s) to be the final shared AP(s). The initial control frame may serve the role of polling the candidate AP(s) regarding their interest in participating in the c-TDMA. For example, the initial control frame and the corresponding response frame (e.g., an initial control response frame (ICR)) may include information regarding the quality of service (QoS) characteristics of the traffic to be processed during the c-TDMA such as access category (AC), traffic identifier (TID), and stream classification service identifier (SCSID) for the traffic. Through the initial control frame and initial control response frame exchange, the sharing AP may be able to obtain information that can help it decide which candidate shared AP(s) should be selected as the final shared AP(s) for TXOP sharing. If multiple candidate shared APs are selected to be the final shared APs (e.g., as shown in FIG. 12), the sharing AP may sequentially share portions of its TXOP with the selected candidate shared APs.

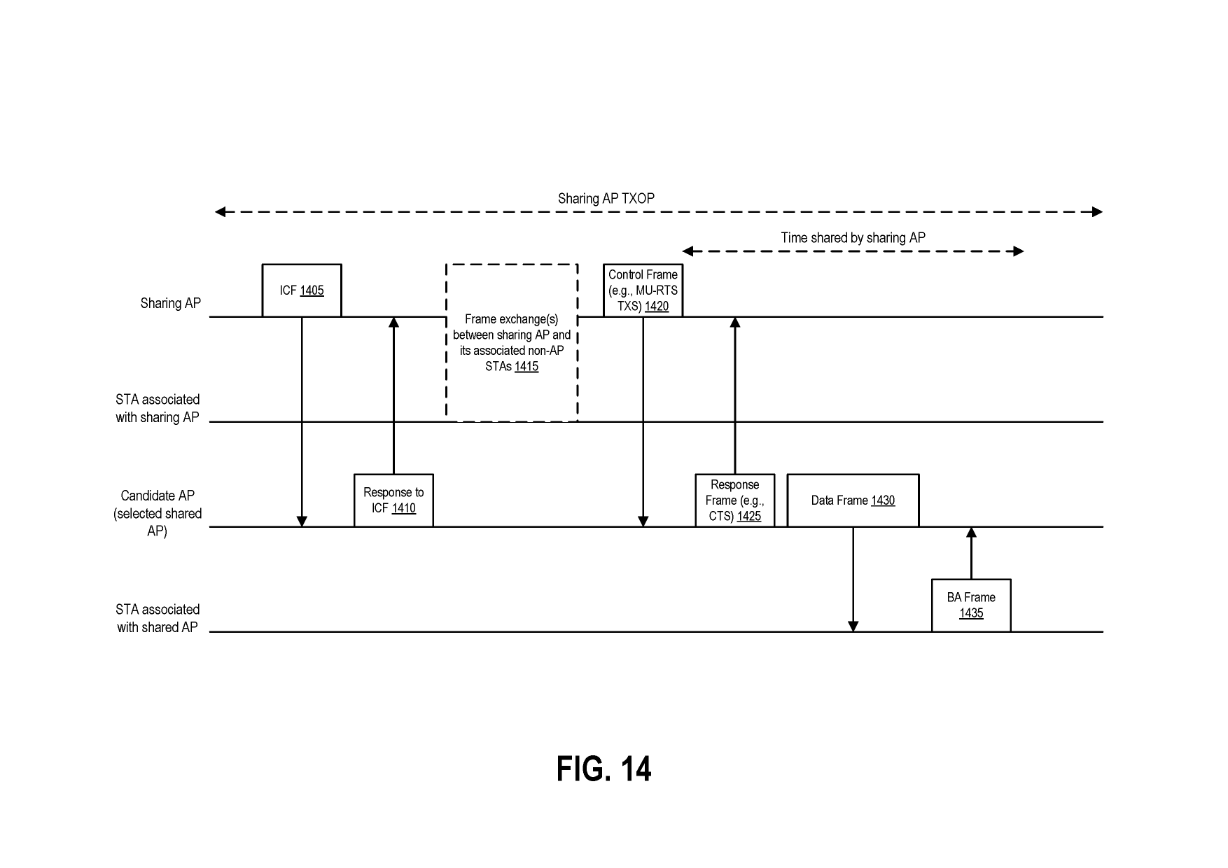

FIG. 14 is a diagram showing a polling phase and in-BSS frame exchange being performed before a TXOP allocation phase, according to some embodiments.

The example shown in the diagram is an example where the sharing AP polls a single candidate shared AP regarding its interest in participating in the c-TDMA and selects the single candidate shared AP to be the final shared AP to participate in the c-TDMA.

As shown in the diagram, the sharing AP may transmit an initial control frame 1405 to the candidate shared AP. The candidate shared AP may transmit a response frame 1410 to the sharing AP as a response to initial control frame 1405. The sharing AP may then select the candidate shared AP to participate in the c-TDMA (e.g., because the candidate shared AP’s response may indicate that it is interested in participating in the c-TDMA).

However, before allocating a portion of its TXOP to the selected candidate shared AP, the sharing AP may use the TXOP to perform frame exchange 1415 with its in-BSS non-AP STAs (STAs that are associated with the sharing AP).

After performing frame exchange 1415, the sharing AP may transmit control frame 1420 to the candidate shared AP to share a portion of its TXOP with the candidate shared AP. In an embodiment, control frame 1420 is a MU-RTS TXS frame. Responsive to receiving control frame 1420, the candidate shared AP may transmit response frame 1425 to the sharing AP. In an embodiment, response frame 1425 is a CTS frame. As a result, the candidate shared AP becomes the final shared AP. During the portion of the TXOP allocated to the candidate shared AP (depicted as “Time shared by sharing AP” in the diagram), the candidate shared AP may transmit data frame 1430 to a STA that is associated with the candidate shared AP. Responsive to receiving data frame 1430, the STA associated with the candidate shared AP may transmit BA frame 1435 to the candidate shared AP.

As shown in this example, the sharing AP may use its TXOP (for transmission and reception with its associated non-AP STAs) before transmitting control frame 1420 to the shared AP (i.e., before sharing a portion of its TXOP with a shared AP).

Multi-user enhanced distributed channel access (MU EDCA) is a channel access mechanism that allows an AP to efficiently manage the channel access of multiple non-AP STAs. The IEEE 802.11ax wireless network standard introduced a feature that allows the AP to trigger multiple non-AP STAs to transmit UL PPDUs. This feature enables the AP to manage multiple non-AP STAs more efficiently. However, to implement this feature, the backoff process between the AP and non-AP STAs needs to be efficiently managed. If the AP and non-AP STAs perform backoff under the same conditions, they may occupy the channel on equal terms. This could reduce the opportunities for the AP to efficiently manage the non-AP STAs.

MU EDCA was introduced to ensure that the AP has a higher probability of occupying the channel and to introduce a "penalty" for non-AP STAs that have transmitted uplink trigger-based (TB) PPDUs (e.g., when the AP transmits a trigger frame to non-AP STA_X to solicit an uplink TB PPDU and non-AP STA_X successfully transmits an uplink TB PPDU to the AP, non-AP STA_X may apply a MU EDCA parameter set instead of the legacy/standard EDCA parameter set).

STAs that transmit quality of service (QoS) data frame in response to receiving a trigger frame from an AP may apply a MU EDCA parameter set. For example, if the AP transmits a trigger frame to a STA, the STA may transmit a QoS data frame of a particular access category (AC) such as the voice access category (AC_VO) to the AP in an uplink TB PPDU. If the QoS data frame requires an acknowledgement, the STA may apply a MU EDCA parameter set after receiving an acknowledgement (ACK) frame from the AP. This means that, after receiving the ACK frame from the AP, the STA should try to access the channel using the MU EDCA parameter set instead of using the legacy/standard EDCA parameter set . If the QoS data frame does not require an acknowledgement, the STA may apply the MU EDCA parameter set after transmitting the QoS data frame. This means that, after transmitting the QoS data frame to the AP, the STA should try to access the channel using the MU EDCA parameter set instead of the legacy/standard EDCA parameter set.

A MU EDCA parameter set may include a MU EDCA timer parameter indicating the duration for which the MU EDCA parameter set should be applied. Also, the MU EDCA parameter set may include a ECWmin/ECWmax parameter that indicates a minimum contention window value and a maximum contention window value.

The AP may provide the MU EDCA parameter set to STAs in a beacon frame or a probe response frame. The MU EDCA parameter set may be provided in a MU EDCA parameter set element, for example, in a MU AC parameter record field of the MU EDCA parameter set element.

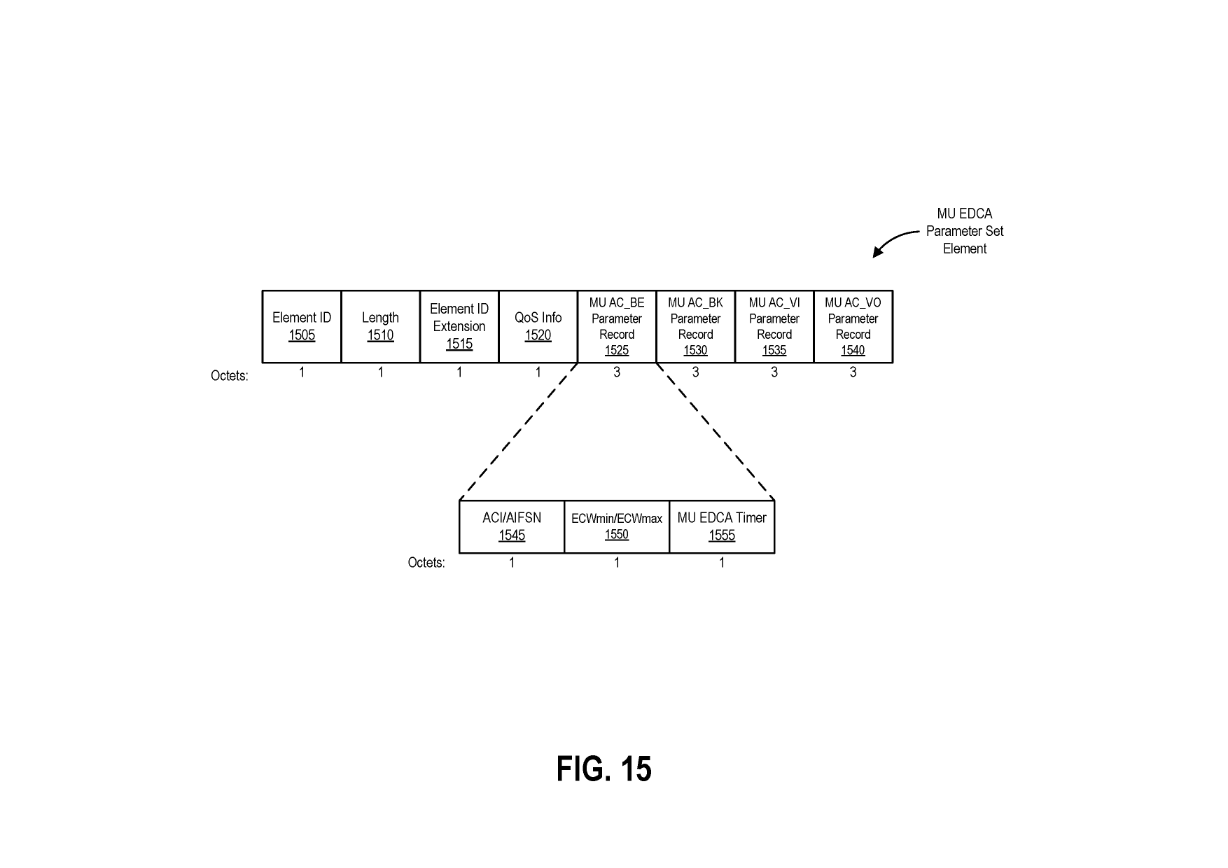

FIG. 15 is a diagram showing a format of a MU EDCA parameter set element, according to some embodiments.

As shown in the diagram, the MU EDCA parameter set element includes an element ID field 1505 (1 octet), a length field 1510 (1 octet), an element ID extension field 1515 (1 octet), a QoS info field 1520 (1 octet), a MU AC_BE (best effort access category) parameter record field 1525 (3 octets), a MU AC_BK (background access category) parameter record field 1530 (3 octets), a MU AC_VI (video access category) parameter record field 1535 (3 octets), and a MU AC_VO (voice access category) parameter record field 1540 (3 octets).

The MU AC_BE parameter record field 1525 may include an ACI/AIFSN field 1545 (1 octet), an ECWmin/ECWmax field 1550 (1 octet), and a MU EDCA timer field 1555 (1 octet). The other MU AC parameter record fields (e.g., the MU AC_BK parameter record field 1530, the MU AC_VI parameter record field 1535, and the MU AC_VO parameter record field 1540) may include similar fields.

The ACI/AIFSN field 1545 may have a format that is similar to the corresponding field in the existing/legacy EDCA parameter set element defined in existing IEEE 802.11 wireless networking standards. If the ACI/AIFSN field 1545 has a value of zero (0), it may indicate that EDCA is disabled for the corresponding AC (AC_BE in this example) for the duration specified by the MU EDCA timer field 1555.

The ECWmin/ECWmax field 1550 may also have a format that is similar to the corresponding field in the existing/legacy EDCA parameter set element defined in existing IEEE 802.11 wireless networking standards.

The MU EDCA timer field 1555 may include an indication of the duration for which the MU EDCA parameter set is to be applied. The duration may be indicated in units of eight (8) time units (TUs). When the MU EDCA timer field 1555 has a non-zero value, it may indicate that EDCA should be disabled for the corresponding duration (and the MU EDCA parameter set should be applied for the duration if AIFSN parameter is set to a non-zero value).

The particular field formats shown in the diagrams are provided by way of example only and are not intended limit embodiments to particular field formats. Some embodiments may use different field formats from what is shown in the diagram. For sake of brevity, only certain fields that are deemed relevant for understanding embodiments are described in additional detail. The other fields can be interpreted in accordance with IEEE 802.11 wireless networking standards.

Prior to the IEEE 802.11ax wireless networking standard, APs and non-AP STAs could exchange a “dot11RTSthreshold” value via beacon frames or probe response frames. After the dot11RTSthreshold value is exchanged, the STA may operate as follows: if the size of the data frame to be transmitted by the STA exceeds the dot11RTSthreshold value, the STA shall perform a RTS/CTS frame exchange procedure before performing a frame exchange that includes an individually addressed data or management frame.

In the IEEE 802.11ax wireless networking standard, the requirement of performing a RTS/CTS frame exchange can depend on the TXOP duration. This is because in dense network scenarios, non-AP HE STAs (i.e., IEEE 802.11ax devices) can effectively mitigate interference from surrounding OBSS STAs by transmitting control frames before transmitting data frames.

For example, a non-AP STA may set the duration/ID field of the RTS/CTS frame(s) to the TXOP duration to provide longer protection compared to PPDU length-based settings. Non-AP HE STAs may indicate their capability to support TXOP duration-based RTS/CTS threshold in a HE operation element. The HE operation element may be provided in a beacon frame or a probe response frame.

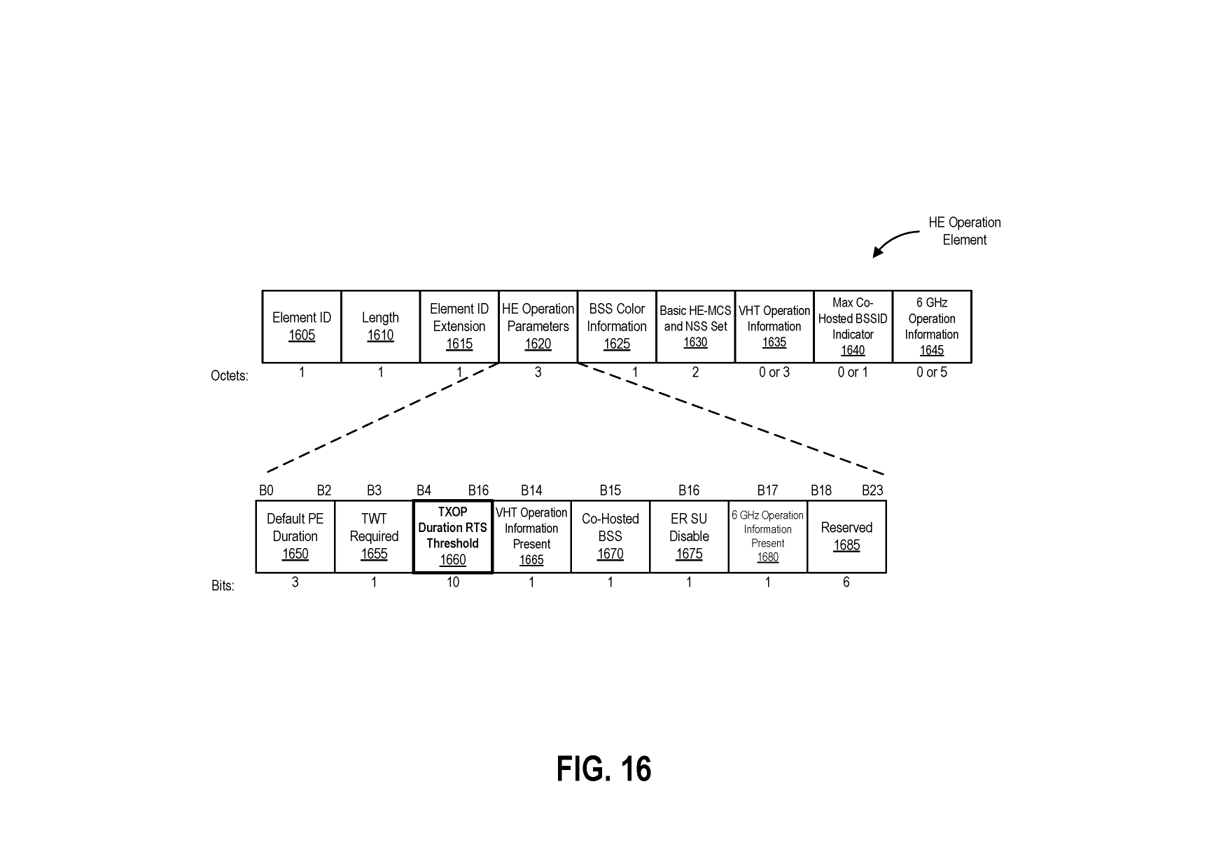

FIG. 16 is a diagram showing a format of a HE operation element field, according to some embodiments.

As shown in the diagram, the HE operation element field may include an element ID field 1605 (1 octet), a length field 1610 (1 octet), an element ID extension field 1615 (1 octet), a HE operation parameters field 1620 (3 octets), a BSS color information field 1625 (1 octet), a basic HE-MCS and NSS set field 1630 (2 octets), a VHT operation information field 1635 (0 or 3 octets), a max co-hosted BSSID indicator field 1640 (0 or 1 octet), and a 6 GHz operation information field 1645 (0 or 5 octets).

The HE operation parameters field 1620 may include a default PE duration field 1650 (3 bits), a TWT required field 1655 (1 bit), a TXOP duration RTS threshold field 1660 (10 bits), a VHT operation information present field 1665 (1 bit), a co-hosted BSS field 1670 (1 bit), a ER SU disable field 1675 (1 bit), a 6 GHz operation information present field 1680 (1 bit), and a reserved field 1685 (6 bits).

Upon receiving a HE operation element, a non-AP HE STA may determine whether to perform TXOP duration-based RTS/CTS transmission based on the value included in the TXOP duration RTS threshold field 1660. For example, if the value included in the TXOP duration RTS threshold field 1660 is decimal 1023, the non-AP HE STA will not perform a TXOP duration-based RTS/CTS exchange. That is, the non-AP HE STA will disable TXOP duration-based RTS/CTS frame exchange. However, if the value included in the TXOP duration RTS threshold field 1660 is between 1 and 1022, the non-AP HE STA may perform TXOP duration-based RTS/CTS exchange. If the value is 0, it may indicate that the previously specified value (e.g., specified in the previous beacon frame) should be used.

If the non-AP HE STA obtains the value from the TXOP duration RTS threshold field 1660 and confirms the feasibility of performing a TXOP duration-based RTS/CTS frame exchange, the STA should initiate an obtained TXOP with a RTS/CTS frame exchange when both of the following conditions are satisfied.

Condition 1: The STA intends to transmit an individually addressed frame to the HE AP or tunneled direct link setup (TDLS) peer STA. This implies that the STA must begin the obtained TXOP with a RTS/CTS frame exchange only when transmitting to the HE AP or a TDLS peer STA.

Condition 2: The duration of the obtained TXOP is equal to or longer than: 32 μs×(TXOP duration RTS threshold value (e.g., 1–1022)). For example, if the duration of the obtained TXOP is 4 milliseconds (ms) and the TXOP duration RTS threshold value is 100, then the STA should initiate the obtained TXOP with a RTS/CTS frame exchange because 4 ms is greater than 32μs×100 (i.e., 4 ms > 32μs×100=3.2 ms).

If the non-AP HE STA follows the above conditions, it may follow the RTS enablement rules defined in the IEEE 802.11ax wireless networking standard. If the non-AP HE STA does not meet these conditions, it may follow the RTS enablement rules prior to the IEEE 802.11ax wireless networking standard.

In the c-TDMA process, the sharing AP may indicate to the shared AP that a TXOP return is allowed/requested through an initial control frame (ICF) and/or MU-RTS TXS frame. Upon receiving such an indication from the sharing AP, the shared AP may return the TXOP if it finishes transmission and reception early (before its allocated portion of the sharing AP’s TXOP expires). The shared AP may return the TXOP by transmitting a TXOP return frame to the sharing AP. Even if the shared AP transmits a TXOP return frame to the sharing AP, the sharing AP may not be able to receive the TXOP return frame because STAs that are not protected by the c-TDMA protocol (e.g., non-AP STAs associated with the sharing AP and/or OBSS STAs) may interfere with the TXOP return frame. When the sharing AP allows/requests a TXOP return, it is necessary to create conditions that improve the probability that the sharing AP can successfully receive the TXOP return frame.

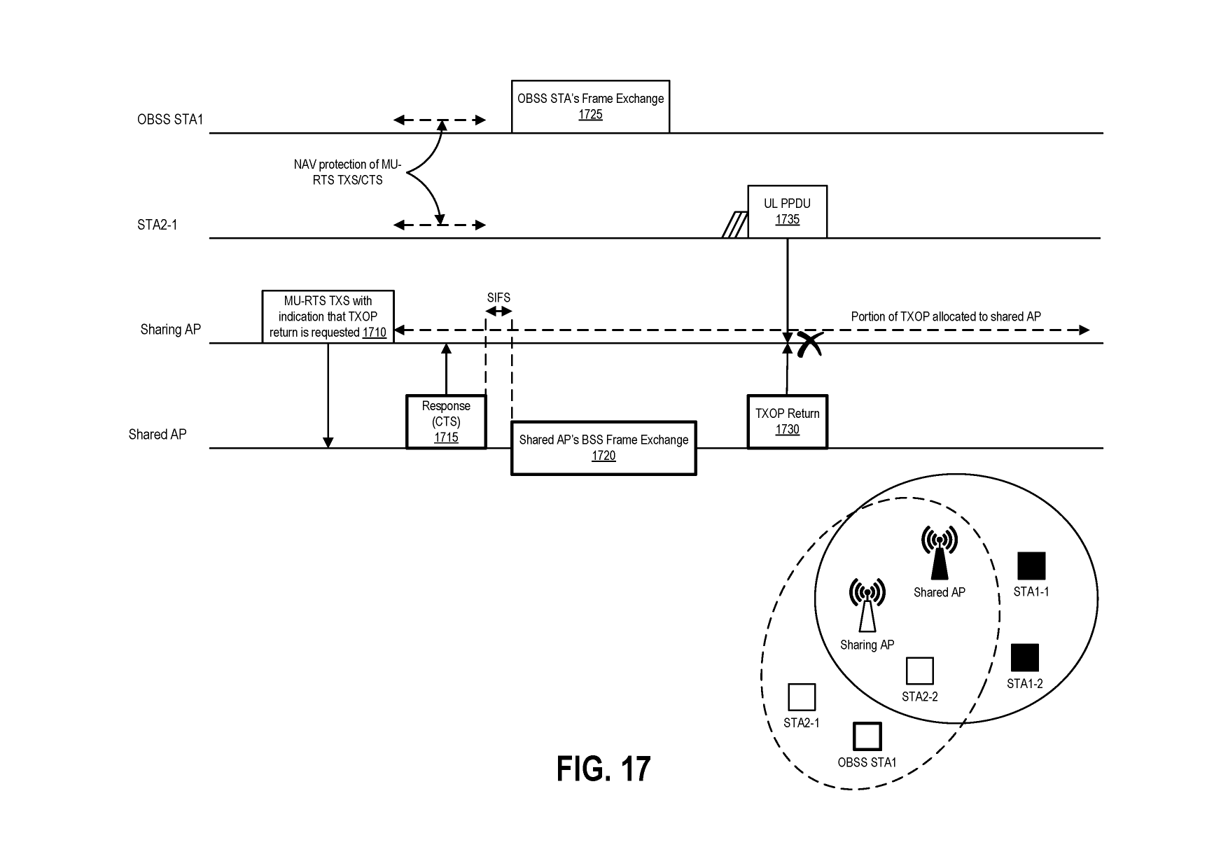

FIG. 17 is a diagram showing a situation where a TXOP return frame is not properly received due to interference, according to some embodiments. The situation may occur in a wireless network having the topology shown in the diagram. The wireless network may include a sharing AP, a shared AP, STAs associated with the sharing AP (STA2-1 and STA2-2), STAs associated with the shared AP (STA1-1 and STA1-2), and an OBSS STA (a STA that is neither associated with the sharing AP or the shared AP).

As shown in the diagram, the sharing AP may transmit MU-RTS TXS frame 1710 to the shared AP to indicate that the sharing AP is allocating a portion of the sharing AP’s TXOP to the shared AP. MU-RTS TXS frame 1710 may include an indication of the duration of the portion of the TXOP being allocated to the shared AP. Also, MU-RTS TXS frame 1710 may include an indication that TXOP return is allowed/requested if the shared AP finishes transmission and reception early. Responsive to receiving MU-RTS TXS frame 1710, the shared AP may transmit response frame 1715 to the sharing AP. In an embodiment, response frame 1715 is a CTS frame. MU-RTS TXS frame 1710 may cause a NAV to be set to protect the transmission of response frame 1715. For example, the duration/ID field included in the MU-RTS TXS frame may be set to the minimum value required for avoiding overprotection of OBSS (e.g., set to a duration corresponding to SIFS interval duration + duration of CTS frame). In this example, the NAV duration is set to last until the end of the response frame 1715 (CTS frame) transmission. After a SIFS interval after transmitting response frame 1715, the shared AP may perform a frame exchange 1720 in the shared AP’s BSS. During the portion of the sharing AP’s TXOP allocated to the shared AP, OBSS STAs such as OBSS STA1 may perform a frame exchange 1725. After performing frame exchange 1720, the shared AP may transmit TXOP return frame 1730 to the sharing AP to return the TXOP back to the sharing AP. However, as shown in the diagram, STA2-1 may transmit UL PPDU 1735 to the sharing AP, which interferes with TXOP return frame 1730.

STA2-1 is a non-AP STA associated with the sharing AP. STA2-1 is in a hidden relationship with the shared AP, meaning it is not within the shared AP’s transmission range. After the MU-RTS TXS frame 1710 and response frame 1715 exchange between the sharing AP and the shared AP, STA2-1 might attempt to occupy the channel. This is because STA2-1 can attempt to transmit after the NAV protection interval established by the MU-RTS TXS frame 1710 and response frame 1715 exchange ends. If STA2-1 successfully occupies the channel, the following problems may arise. After the MU-RTS TXS frame 1710 and response frame 1715 exchange, STA2-1 may transmit a UL PPDU 1735 to the sharing AP. Simultaneously, the shared AP may transmit TXOP return frame 1730 to the sharing AP. As a result, the UL PPDU 1735 transmitted by STA2-1 and TXOP return frame 1730 transmitted by the shared AP may collide, preventing the sharing AP from properly receiving TXOP return frame 1730.

The sharing AP may be unable to receive TXOP return frame 1730 due to interference from the UL PPDU 1735 transmitted by STA2-1. Thus, STA2-1's behavior can negatively impact the shared AP’s TXOP return.

A mechanism is described herein to address the problem where a non-AP STA that is associated with the sharing AP and hidden from the shared AP (e.g., STA2-1) interferes with the TXOP return frame transmitted by the shared AP to the sharing AP.

STA2-2 is a non-AP STA associated with the sharing AP. STA2-2 is not in a hidden relationship with the shared AP, meaning it is within the shared AP’s transmission range. Similar to STA2-1, STA2-2 might attempt to occupy the channel after the MU-RTS TXS frame 1710 and response frame 1715 exchange. However, STA2-2 is unable to occupy the channel because the shared AP starts performing frame exchange 1720 after a SIFS interval after transmitting response frame 1715. This prevents STA2-2 from occupying the channel. Thus, STA2-2 does not affect the TXOP return process, so its behavior is not addressed in detail in the present disclosure.

OBSS STA1 is an AP STA or non-AP STA that is not associated with the sharing AP. OBSS STA1 may be in a hidden relationship with the shared AP, meaning it is not within the shared AP’s transmission range. After the MU-RTS TXS frame 1710 and response frame 1715 exchange between the sharing AP and the shared AP, OBSS STA1 may attempt to occupy the channel. The present disclosure focuses mainly on the c-TDMA operation between the sharing AP and shared AP, and does not try to control OBSS operation (controlling OBSS operation (e.g., restricting OBSS channel access) might lead to over-protection). Thus, OBSS STA1’s behavior is not addressed in detail in the present disclosure.

Thus, in a c-TDMA scenario where TXOP return is allowed, the shared AP may transmit a TXOP frame to the sharing AP if the shared AP finishes transmission and reception early. However, a non-AP STA associated with the sharing AP but hidden from the shared AP may occupy the channel to transmit a UL PPDU to the sharing AP. If the transmission of the UL PPDU and the TXOP return frame overlap, a collision may occur, which may prevent the sharing AP from properly receiving the TXOP return frame. In such case, the sharing AP may not recognize the TXOP return and thus the transmission of the TXOP return frame becomes meaningless, which can degrade the wireless network performance.

A mechanism is described herein to increase the probability of the sharing AP being able to properly receive the TXOP return frame from the shared AP. The mechanism may leverage a MU EDCA mechanism and/or RTS enablement mechanism to increase the probability that the sharing AP can properly receive a TXOP return frame from the shared AP.

In an embodiment, the mechanism provides STAs associated with the sharing AP with a MU EDCA parameter set that the STAs are to apply during the c-TDMA procedure so that the STAs do not transmit UL PPDUs during the c-TDMA procedure or so that the STAs transmit UL PPDUs with a lower probability during the c-TDMA procedure. This allows the sharing AP to properly receive a TXOP return frame from the shared AP. The MU EDCA parameter set update can happen during any of three stages of a c-TDMA procedure.

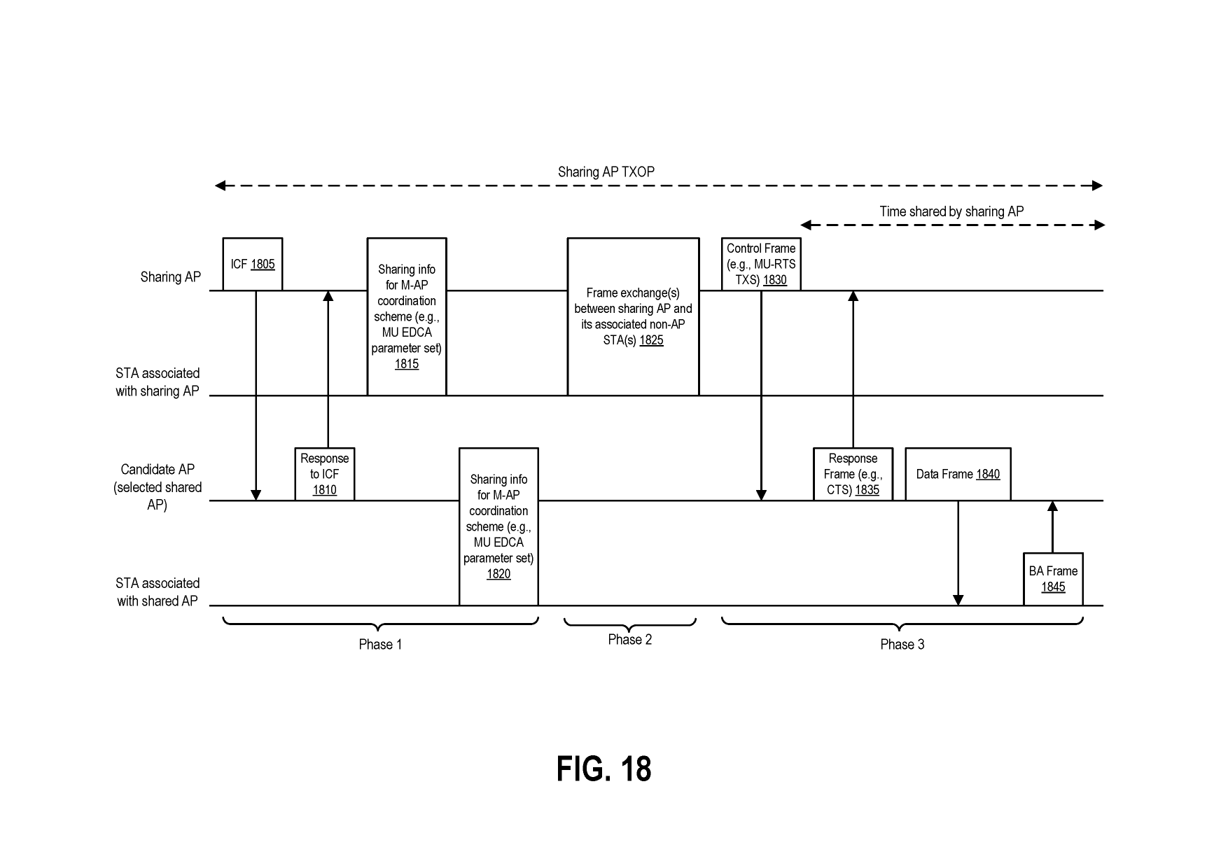

FIG. 18 is a diagram showing three phases of a c-TDMA procedure, according to some embodiments.

A c-TDMA procedure can include three phases. The first phase (Phase 1) may establish the multi-AP coordination framework, the second phase (Phase 2) may pre-implement the multi-AP coordination scheme, and the third phase (Phase 3) may implement the multi-AP coordination scheme.

As shown in the diagram, during Phase 1, the sharing AP may transmit an initial control frame (ICF) 1805 to a candidate AP and the candidate AP may respond by transmitting a response frame 1810 to the sharing AP. The ICF 1805 and response frame 1810 exchange may involve exchanging various details regarding the operation, configuration, and application of the MU EDCA parameter set. Subsequently, each AP may share the exchanged information with its associated non-AP STAs. For example, the sharing AP may share information 1815 regarding the multi-AP coordination scheme, including the MU EDCA parameter set, with its associated STAs. Also, the shared AP may share information 1820 regarding the multi-AP coordination scheme, including the MU EDCA parameter set, with its associated STAs. The information may be shared in management frames (e.g., (public) action frames, beacon frames, probe responses, etc.), control frames, and/or QoS data frames (e.g., in an aggregated control (A-control) field). While the diagram shows an example where the AP-to-AP exchange happens before the APs share information with their associated non-AP STAs, it should be appreciated that the information sharing can happen in the opposite order. That is, the APs may first share information with their associated STAs and then the APs may later exchange information with each other. The outcome of Phase 1 is that all STAs participating in the multi-AP coordination scheme are enabled for MU EDCA operation and are aware of the updated MU EDCA parameter set.

As shown in the diagram, during Phase 2, the sharing AP may perform frame exchange 1825 with its associated non-AP STAs before the sharing AP shares its TXOP with the shared AP. During this phase, the sharing AP may provide the details of the MU EDCA parameter set to its associated STAs in management frames (e.g., (public) action frames, beacon frames, and/or probe responses), control Frames, and/or QoS data frames (e.g., in an A-control field).

As shown in the diagram, during Phase 3, the sharing AP may transmit control frame 1830 to the candidate AP to indicate that the sharing AP is allocating a portion of the sharing AP’s TXOP to the candidate AP. The candidate AP thus becomes the selected/final shared AP. Responsive to receiving control frame 1830, the shared AP may transmit response frame 1835 to the sharing AP. In an embodiment control frame 1830 is a MU-RTS TXS frame and response frame 1835 is a CTS frame. Phase 3 may be considered to start at the time of the control frame exchange (e.g., MU-RTS TXS and CTS frame exchange) or after the control frame exchange. During the portion of the TXOP allocated to the shared AP, the shared AP may transmit data frame 1840 to a STA associated with the shared AP and the STA may respond by transmitting block acknowledgment (BA) frame 1845 to the shared AP. The sharing AP may provide a MU EDCA parameter set to its associated STAs during this phase in management frames (e.g., (public) action frames, beacon frames, and/or probe response frame), control frames, and/or QoS data frames (via the A-control field).

The mechanism described herein enhances the efficiency of the multi-AP coordination scheme (and specifically the c-TDMA scheme) by modifying the MU EDCA parameter set. The mechanism can be applied during any of the phases (e.g., Phase 1, Phase 2, or Phase 3) to enhance coordination among the sharing AP, shared APs, and their associated STAs.

Non-AP STAs may be provided with a MU EDCA parameter set that they can apply to allow efficient multi-AP coordination. Non-AP STAs may apply the MU EDCA parameter set according to MU EDCA rules after transmitting QoS data frames in TB PPDUs. UHR non-AP STAs may follow two approaches: 1) apply MU EDCA only for TB PPDU-based QoS Data frame transmissions; and 2) apply MU EDCA regardless of TB PPDU transmissions, imposing penalties for channel access attempts to prevent interference.

The MU EDCA parameter set may be set in a manner that reduces the uplink transmission probability of STAs. This may reduce the uplink transmission probability of STAs that are hidden to the shared AP during c-TDMA, which may allow the sharing AP to more reliably receive a TXOP return frame (e.g., receive it without interference) from the shared AP.

Information regarding the MU EDCA parameter set (e.g., operation, configuration, and application methods) may be exchanged during Phase 1 (initial negotiation and setup), Phase 2 (pre-operation preparation within BSS), and/or Phase 3 (during multi-AP scheme operation).

The MU EDCA parameter set may include an ACI/AIFSN parameter, a ECWmin/ECWmax parameter, and a MU EDCA timer parameter.

The MU EDCA timer parameter can be configured using various methods.

According to a first method (Method 1), the MU EDCA timer parameter is set based on a maximum TXOP value. The MU EDCA timer parameter may be set to the maximum TXOP limit for the corresponding AC. For example, if a non-AP STA transmits AC_VO data via a TB PPDU, the non-AP STA may be prevented from transmitting further uplink AC_VO data until the timer expires.

According to a second method (Method 2), the MU EDCA timer parameter is set based on the longest TXOP duration allowed in the extended service set (ESS). This method ensures consistent operation across all ACs.

According to a third method (Method 3), the MU EDCA timer parameter is set based on an AC-specific TXOP duration (e.g., a predefined TXOP limit for the corresponding AC +/- @, where @ can be an arbitrary value that can depend on the scenario/implementation).

According to a fourth method (Method 4), the MU EDCA timer parameter is dynamically set based on the remaining time in the TXOP during Phase 1, Phase 2, or Phase 3. For example, if Phase 1 involves a frame exchange with a specific TXOP, the MU EDCA timer parameter may be set to the remaining duration (until the TXOP expires).

The AIFSN parameter may be set to a value of 0 (AIFSN = 0) to prevent uplink transmission during the MU EDCA timer period, suspending EDCA operation. The AIFSN parameter may be set to a non-zero value if uplink blocking is not feasible. In this case, the ECWmin/ECWmax parameter may be set to reduce the channel access probability.

The ECWmin/ECWmax parameter may be adjusted to increase the backoff duration, penalizing channel access attempts. For example, a STA transmitting AC_VO data via a TB PPDU may use the adjusted ECWmin/ECWmax parameter values of the MU EDCA parameter set to reduce future access probability for AC_VO data.

There may be two cases for applying the MU EDCA parameter set. The first case is when the AIFSN parameter is set to value of zero (0). In this case, channel access is prevented during the time indicated by the MU EDCA timer parameter. The second case is when the AIFSN parameter is set to a non-zero value. In this case, channel access is not completely blocked, but the ECWmin/max parameter values can be increased to significantly reduce the channel access probability.

However, situations may arise where the shared AP completes its transmission and reception before the MU EDCA timer expires. For example, consider a Phase 1 Method 4 scenario, where the MU EDCA parameter set is provided to a non-AP STA that is associated with the sharing AP and that is in a hidden relationship with the shared AP. This non-AP STA may transmit a QoS data frame for a specific AC in a TB PPDU to the sharing AP in response to receiving a trigger frame from the sharing AP prior to the sharing AP allocating a portion of its TXOP to the shared AP. As a result, the following actions may be taken during the MU EDCA timer period for the corresponding AC. When the AIFSN parameter is set to zero (0), channel access is not attempted during the MU EDCA timer period. When the AIFSN parameter is set to a non-zero value, channel access is attempted using the increased ECWmin/ECWmax parameter values during the MU EDCA timer period.

In this example, assuming that the AIFSN parameter is set to a value of zero (0), the non-AP STA does not attempt channel access during the MU EDCA timer period. The following scenarios can be considered.

In a first scenario (Scenario 1), the shared AP may transmit a TXOP return frame to the sharing AP and the sharing AP successfully receives it. This means that the sharing AP has regained channel occupancy rights. In a second scenario (Scenario 2), the shared AP may continuously attempt to transmit a TXOP return frame to the sharing AP but the sharing AP fails to receive it, causing the channel to return to a contention free state. Despite the channel being in a contention free state, the sharing AP may obtain channel occupancy rights (though recovery). In a third scenario (Scenario 3), the shared AP, having not received an indication from the sharing AP to return the TXOP, completes transmission and reception before its allocated portion of the TXOP expires, leading to TXOP abortion. This means that the channel returns to a contention free state. However, it is assumed that the sharing AP obtains channel access rights through recovery.

Considering these scenarios, if the sharing AP reobtains the TXOP from the shared AP, this means that the sharing AP has an opportunity for transmission and reception. However, unlike the sharing AP, the non-AP STA is unable to attempt channel access until the MU EDCA timer period expires.

This may raise the following issues. The sharing AP may reobtain the TXOP and plan to resume transmission and reception with its in-BSS devices. The in-BSS devices of the sharing AP may include STAs that are operating under the MU EDCA timer (applying the MUE EDCA parameter set) and STAs that are not operating under the MU EDCA timer. However, the remaining TXOP duration is insufficient to resume transmission and reception. As a result, the sharing AP quickly loses its role as a TXOP holder. If STAs operating under the MU EDCA timer are not managed in this situation, the following problems may occur. The STA operating under the MU EDCA timer may receive a penalty that is equivalent to the MU EDCA timer duration. The duration of the MU EDCA timer may be set as an extended value beyond the baseline MU EDCA timer duration to enable efficient M-AP schemes. If the early termination of the M-AP scheme eliminates the need to maintain the MU EDCA timer, the STAs maintaining the MU EDCA timer may lose channel access opportunities. Also, if there is a large gap between the duration for which the sharing AP can maintain the TXOP and the duration of the MU EDCA timer, fairness issues may arise between STAs operating under the MU EDCA timer and STAs not operating under the MU EDCA timer.

In an embodiment, to resolve this issue, when the sharing AP reobtains the TXOP earlier than expected, it may reset the MU EDCA timer to have a duration of zero (0) for STAs operating under the MU EDCA timer. A MU EDCA reset frame can be used to rest the MU EDCA timer. The MU EDCA reset frame is an action frame that may include the following fields: a category field, a protected HE action field, and a MU EDCA control field. When the value of the Protected HE action field is “1”, it may indicate a "MU EDCA reset." Additionally, the MU EDCA control field may include an affected ACs field, which may contain a bitmap indicating which ACs the MU EDCA reset applies to. By setting all bits in this field to “1”, the MU EDCA timer can be reset for all ACs. If a non-AP STA operating under the MU EDCA timer receives a MU EDCA reset frame from the sharing AP, it may reset the MU EDCA timer duration for the ACs indicated by the bitmap to “0” and attempt channel access using the legacy/standard EDCA parameter set. The MU EDCA reset frame may be transmitted using an individual address or a group address.

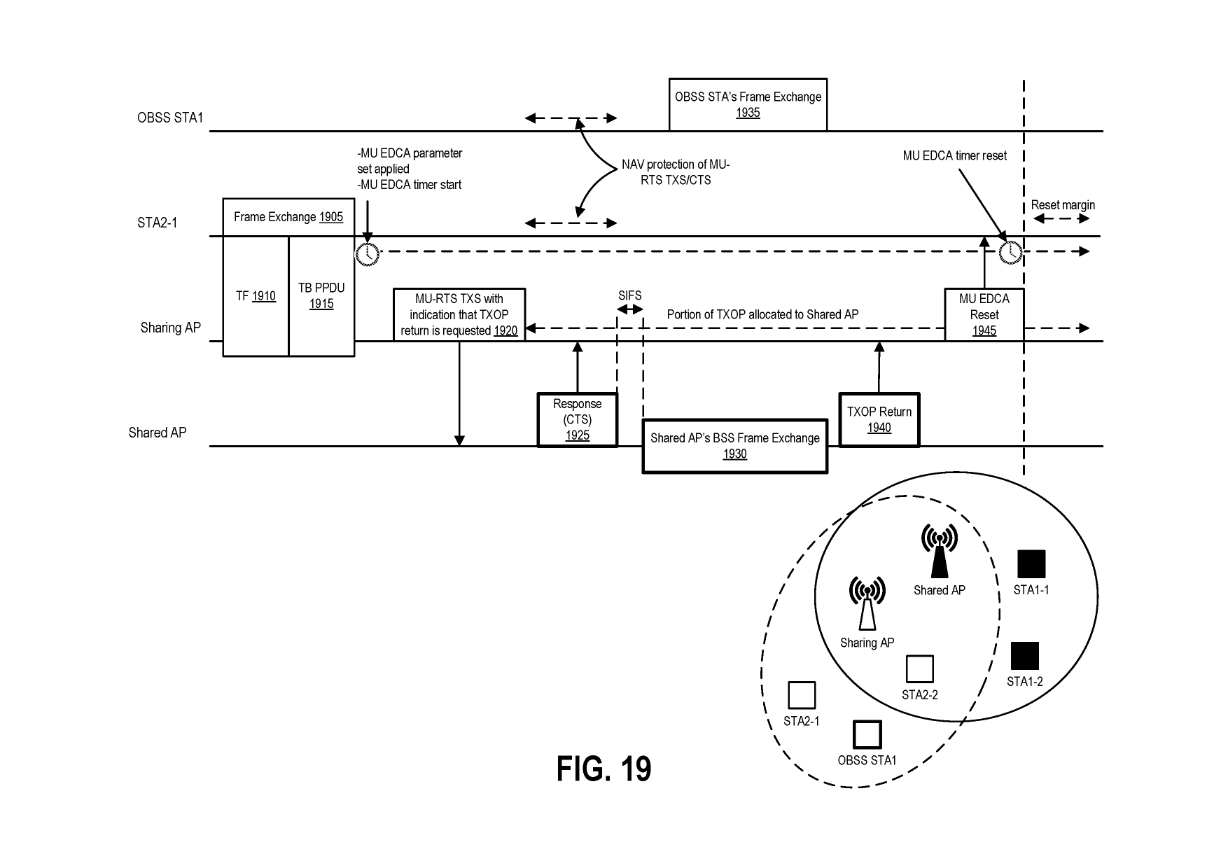

FIG. 19 is a diagram showing an example of applying a MU EDCA parameter set to allow the sharing AP to properly receive a TXOP return frame, according to some embodiments.

In this example, it is assumed that the MU EDCA parameter set was exchanged during Phase 1 and that the MU EDCA timer parameter is set according to Method 4 (e.g., the sharing AP can dynamically set the MU EDCA timer parameter to the remaining duration in the TXOP). Also, it is assumed that the AIFSN parameter is set to a value of zero (0) to prevent channel access for the corresponding AC.

As shown in the diagram, the sharing AP and STA2-1 and may perform frame exchange 1905, which may involve the exchange of trigger frame 1910 and trigger-based PPDU 1915. After transmitting trigger-based PPDU 1915, STA2-1 may apply a MU EDCA parameter set and start the MU EDCA timer. In this example, Phase 1 and Phase 2 are finished at the time the MU EDCA parameter set is applied. Thus, if the total TXOP duration is 100 time units and 10 time units are used for Phase 1 and 20 time units are used for Phase 2, then the remaining duration in the TXOP is 70 time units (100-10-20 = 70) so the MU EDCA timer parameter may have been set to 70 time units. This may allow the sharing AP to properly receive TXOP return frame 1940 from the shared AP.

The sharing AP may transmit MU-RTS TXS frame 1920 to the shared AP with an indication that TXOP return is requested. The transmission of the MU-RTS TXS frame 1920 may allocate a portion of the sharing AP’s TXOP to the shared AP. The shared AP may respond by transmitting response frame 1925 (which may be a CTS frame). After a SIFS interval after transmitting response frame 1925, the shared AP’s BSS may perform frame exchange 1930. During the portion of the TXOP allocated to the shared AP, OBSS STA1 may perform a frame exchange 1935 in the OBSS. After the completion of frame exchange 1930, the shared AP may transmit TXOP return frame 1940 to the sharing AP if the shared AP’s BSS finishes transmission and reception early (before the portion of the TXOP allocated to the shared AP expires). The sharing AP may determine that the time remaining in the TXOP is insufficient to resume transmission and reception for its in-BSS devices. In response to receiving TXOP return frame 1940, the sharing AP may transmit MU EDCA reset frame 1945 to STA2-1 to reset STA2-1’s MU EDCA timer (to a duration of zero (0)). After a reset margin, STA2-1 may apply the legacy/standard EDCA parameter set instead of the MU EDCA parameter set.

The MU EDCA parameter set may be applied to suppress the uplink traffic of a non-AP STA that is associated with the sharing AP and hidden from the shared AP (e.g., STA2-1) so that the sharing AP can properly receive a TXOP return frame from the shared AP. However, it might not be possible to have all STAs associated with the sharing AP to apply the MU EDCA parameter set. This is because it might not be possible to solicit UL trigger-based PPDU from all non-AP STAs associated with the sharing AP. To address this issue, in an embodiment, RTS enablement can be additionally applied to reduce the potential interference of the non-AP STAs associated with the sharing AP. With the RTS enablement feature, a STA that successfully gains channel access should transmit a RTS frame at the beginning of the TXOP. For example, if STA2-1 does not have its NAV set during the portion of the TXOP allocated to the shared AP, it should transmit a RTS frame if it obtains a TXOP.

RTS enablement may function as follows, depending on whether the device is pre-11ax or post-11ax STA.

For a pre-11ax STA, if a PPDU to be transmitted is larger than the size specified by dot11RTSthreshold (which can be exchanged via beacon/probe response frames), a RTS/CTS frame exchange should precede the transmission of the PPDU. In an embodiment, to suppress the UL PPDU transmission of non-AP STAs associated with the sharing AP and hidden from the shared AP, the dot11RTSthreshold value is set to a low value (e.g., to require the STA to transmit a RTS frame before transmitting a PPDU).

For a post-11ax STA, if the TXOP duration acquired during channel access exceeds the TXOP duration RTS threshold, the TXOP should start with a RTS/CTS frame exchange. In an embodiment, to suppress the UL PPDU transmission of non-AP STAs associated with the sharing AP and hidden from the shared AP, the TXOP duration RTS threshold value is set to a low value (e.g., to require the STA to transmit a RTS frame at the beginning of the TXOP).

In an embodiment, before performing multi-AP coordination, each AP may configure its associated STAs with the low RTS threshold or TXOP duration RTS threshold values to suppress uplink transmission by those STAs.

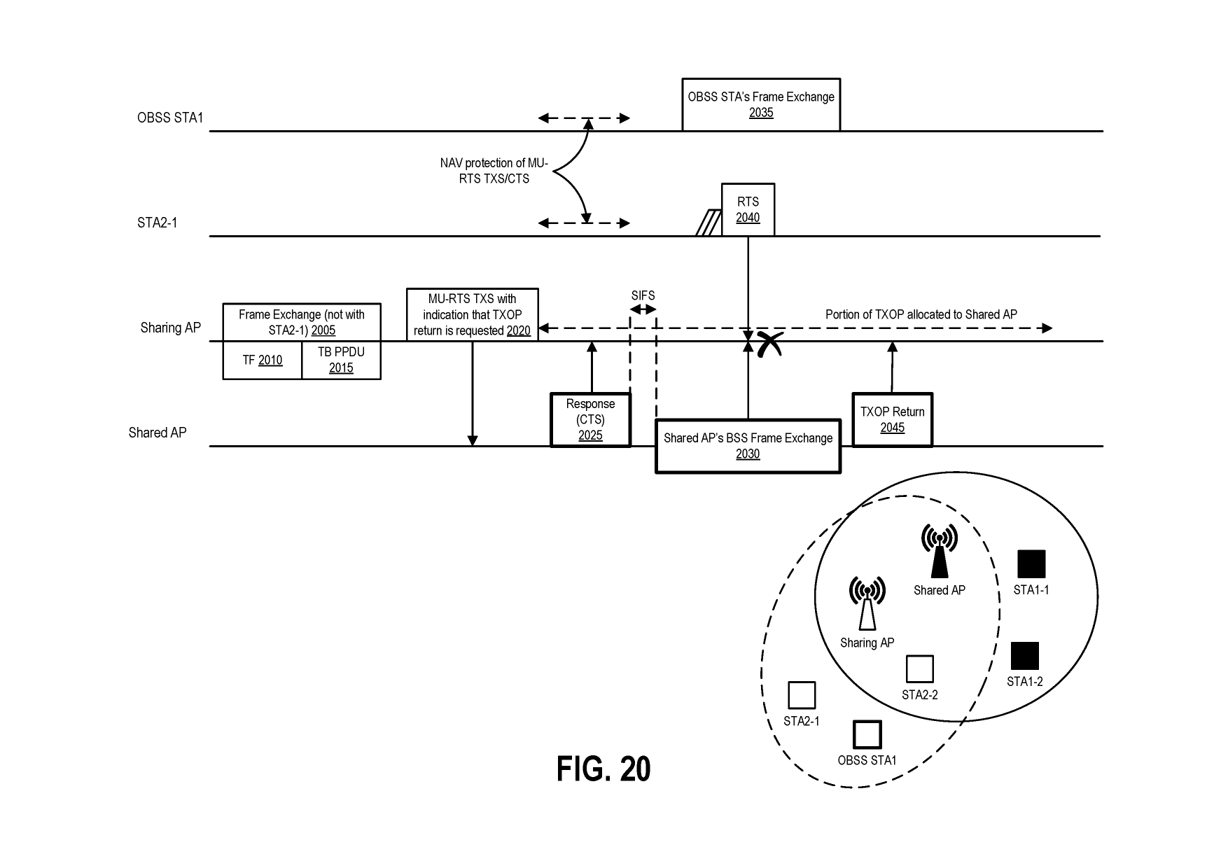

FIG. 20 is a diagram showing an example of applying RTS enablement to allow the sharing AP to properly receive a TXOP return frame, according to some embodiments.

As shown in the diagram, the sharing AP and STA2-1 and may perform frame exchange 2005, which may involve the exchange of trigger frame 2010 and trigger-based PPDU 2015.

The sharing AP may transmit MU-RTS TXS frame 2020 to the shared AP with an indication that TXOP return is requested. The transmission of the MU-RTS TXS frame 2020 may allocate a portion of the sharing AP’s TXOP to the shared AP. The shared AP may respond by transmitting response frame 2025 (which may be a CTS frame). After a SIFS interval after transmitting response frame 2025, the shared AP’s BSS may perform frame exchange 2030. During the portion of the TXOP allocated to the shared AP, OBSS STA1 may perform a frame exchange 2035 in the OBSS. After the completion of frame exchange 2030, the shared AP may transmit TXOP return frame 2045 to the sharing AP if the shared AP’s BSS finishes transmission and reception early (before the portion of the TXOP allocated to the shared AP expires).

If STA2-1 is a post-11ax STA (that uses TXOP duration RTS threshold) then it should perform a RTS/CTS frame exchange at the beginning of a TXOP it has obtained if the TXOP duration is longer than the TXOP duration RTS threshold. The TXOP duration RTS threshold may be set to a low value to require the TXOP to begin with a RTS/CTS exchange. Accordingly, STA2-1 may transmit RTS frame 2040 to the sharing AP. The sharing AP, which is in a position to overhear transmissions from the shared AP, may not be able to respond to RTS frame 2040 transmitted by STA2-1. STA2-1, which fails to receive a CTS frame from the sharing AP, may either attempt to retransmit a RTS frame after backoff or may lose the TXOP if channel access is authorized by another STA.

If STA2-1 is a pre-11ax STA (that uses dot11RTSthreshold) then it should perform a RTS/CTS frame exchange at the beginning of a TXOP it has obtained. The dot11RTSthreshold may be set to a low value to require the TXOP to begin with a RTS/CTS frame exchange. Accordingly, STA2-1 may transmit RTS frame 2040 to the sharing AP. The sharing AP, which is in a position to overhear transmissions from the shared AP, may not be able to respond to RTS frame 2040 transmitted by STA2-1. STA2-1, which fails to receive a CTS frame from the sharing AP, may either attempt to retransmit a RTS frame after backoff or may lose the TXOP if channel access is seized by another entity.

The use of RTS enablement as described above may reduce the probability of collisions with TXOP return frames that may transmitted at arbitrary times by preventing non-AP STAs from initially transmitting long PPDUs. This means that the use of the RTS enablement creates conditions where the sharing AP can properly receive TXOP return frames from the shared AP without interference (or with lower probability of interference).

However, in some scenarios, there may be a margin of time where the sharing AP might attempt to respond to a RTS frame. For example, there may be a scenario where the sharing AP successfully receives a RTS frame transmitted by STA2-1 due to the sharing AP not being able to overhear the frame exchange within the shared AP's BSS. In this case, if the sharing AP transmits a CTS frame as response to the RTS frame, STA2-1 may subsequently attempt to transmit data to the sharing AP. If the timing of the shared AP’s transmission of a TXOP return frame overlaps with STA2-1's attempt to transmit data to the sharing AP, the sharing AP may fail to properly receive the TXOP return frame.

To address this issue, the following additional rule can be applied. During the portion of the sharing AP’s TXOP allocated to the shared AP, the sharing AP does not respond to RTS frames transmitted by associated non-AP STAs.

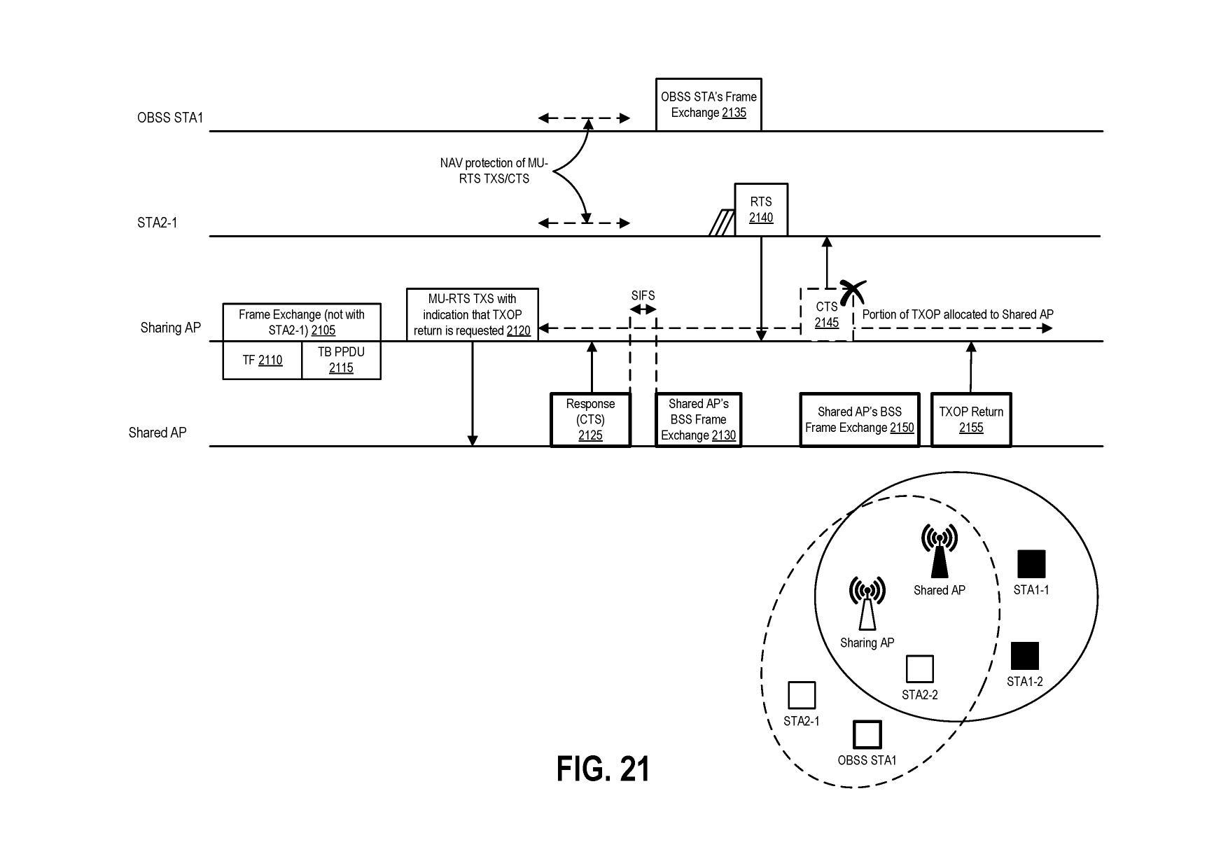

FIG. 21 is a diagram showing an example of applying RTS enablement and where the sharing AP does not respond to a RTS frame, according to some embodiments.

As shown in the diagram, the sharing AP and STA2-1 and may perform frame exchange 2105, which may involve the exchange of trigger frame 2110 and trigger-based PPDU 2115.

The sharing AP may transmit MU-RTS TXS frame 2120 to the shared AP with an indication that TXOP return is requested. The transmission of the MU-RTS TXS frame 2120 may allocate a portion of the sharing AP’s TXOP to the shared AP. The shared AP may respond by transmitting response frame 2125 (which may be a CTS frame). After a SIFS interval after transmitting response frame 2125, the shared AP’s BSS may perform frame exchange 2130 and frame exchange 2150. During the portion of the TXOP allocated to the shared AP, OBSS STA1 may perform a frame exchange 2135 in the OBSS. After the completion of frame exchange 2130 and frame exchange 2150, the shared AP may transmit TXOP return frame 2155 to the sharing AP if the shared AP’s BSS finishes transmission and reception early (before the portion of the TXOP allocated to the shared AP expires).

During the portion of the TXOP allocated to the shared AP, STA2-1 may transmit RTS frame 2140 if it has data to transmit according to RTS enablement rules. The sharing AP may successfully receive RTS frame 2140 because it arrives while there is no transmission in the shared AP’s BSS. However, the sharing AP may refrain from responding to RTS frame 2140 even though the sharing AP has successfully received RTS frame 2140. Specifically, the sharing AP may refrain from transmitting CTS frame 2145. This prevents STA2-1 from attempting to transmit data to the sharing AP, which in turn allows the sharing AP to properly receive TXOP return frame 2155 from the shared AP.

The MU EDCA and RTS enablement methods can be used in combination and be used with legacy devices, as described below.

For HE/EHT/UHR STAs, if the MU EDCA timer parameter is set with the AIFSN parameter being set to zero (0) for all ACs, the non-AP STAs are completely blocked from untriggered transmissions during the MU EDCA timer period. If the MU EDCA timer is set with the AIFSN parameter being set to non-zero value (and the ECWmin/ECWmax parameters are set to increased values), non-AP STAs are not entirely blocked from channel access but their access probability is reduced, thereby preemptively mitigating potential collisions.

When the MU EDCA parameter set cannot be applied (e.g., when control via MU EDCA-related methods is not feasible), RTS enablement may be applied (e.g., enforce TXOP duration-based RTS enablement to ensure that a TXOP begins with a RTS/CTS frame exchange).

If a HE/EHT/UHR STA does not comply with these conditions, the method for pre-HE STAs described below can be followed to resolve the issue. Pre-HE STAs may prioritize the transmission of short PPDUs (e.g., RTS frame transmission). The RTS threshold may be set to a low value to ensure that a RTS frame is transmitted before performing further transmissions. This helps ensure that STAs transmit short PPDUs instead of long data PPDUs, thereby reducing potential collision issues that may arise.

The present disclosure describes a mechanism that allows the sharing AP to properly receive a TXOP return frame from the shared AP. The mechanism may prevent STAs associated with the sharing AP from transmitting UL PPDUs to the sharing AP during a portion of the sharing AP’s TXOP that is allocated to the shared AP or at least reduce the probability of transmitting UL PPDUs to the sharing AP. The mechanism may achieve this by configuring STAs associated with the sharing AP with a temporary channel access parameter set and/or with a lower RTS threshold. The mechanism increases the probability that the sharing AP can properly receive a TXOP return frame from the shared AP, which improves the multi-AP coordination efficiency during c-TDMA.

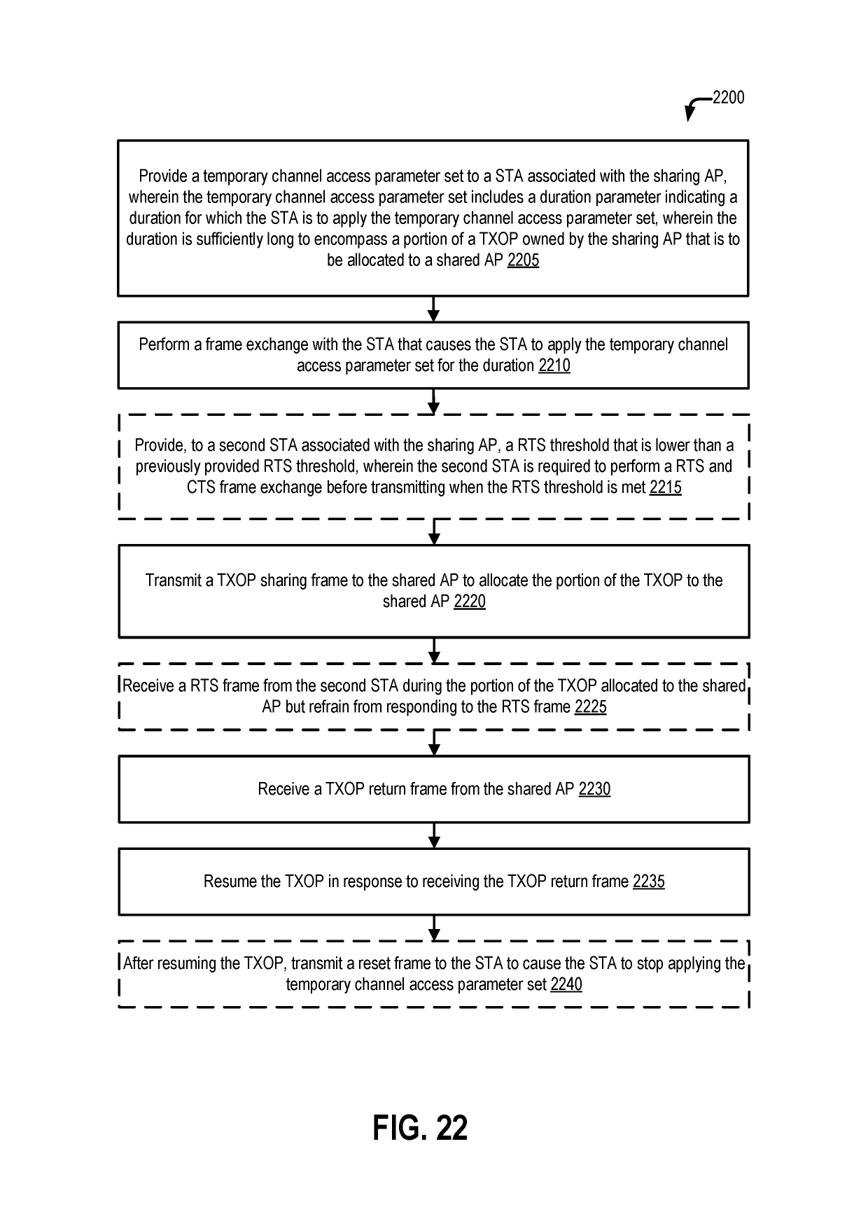

Turning now to FIG. 22, a method 2200 will be described for enabling proper reception of a TXOP return frame during c-TDMA, in accordance with an example embodiment. The method 2200 may be performed by a sharing AP. The sharing AP may be implemented by a wireless device 104.

Additionally, although shown in a particular order, in some embodiments the operations of the method 2200 may be performed in a different order. For example, although the operations of the method 2200 are shown in a sequential order, some of the operations may be performed in partially or entirely overlapping time periods.

At operation 2205, the sharing AP provides a temporary channel access parameter set to a STA associated with the sharing AP, wherein the temporary channel access parameter set includes a duration parameter (e.g., a MU EDCA timer parameter) indicating a duration for which the STA is to apply the temporary channel access parameter set, wherein the duration is sufficiently long to encompass a portion of a TXOP owned by the sharing AP that is to be allocated to a shared AP. In an embodiment, the temporary channel access parameter set further includes an AIFSN parameter indicating that uplink transmission is prohibited. In an embodiment, the AIFSN parameter is set to a value of 0 to indicate that uplink transmission is prohibited. In an embodiment (e.g., when the AIFSN parameter is set to a non-zero value), the temporary channel access parameter set further includes a minimum contention window parameter (e.g., ECWmin parameter) indicating a minimum contention window value and a maximum contention window parameter (e.g., ECWmax parameter) indicating a maximum contention window value, wherein the minimum contention window value and the maximum contention window value are larger compared to a minimum contention window value and a maximum contention window value, respectively, included in a legacy/standard channel access parameter set to reduce a channel access probability of the STA. In an embodiment, the providing the temporary channel access parameter set to the STA comprises transmitting a management frame, a control frame, or a QoS data frame to the STA that includes information regarding the temporary channel access parameter set.

At operation 2210, the sharing AP performs a frame exchange with the STA that causes the STA to apply the temporary channel access parameter set for the duration. In an embodiment, the temporary channel access parameter set is a MU EDCA parameter set and the frame exchange is a trigger-based frame exchange (e.g., an exchange of a trigger frame and a TB PPDU).

In an embodiment, at operation 2215, the sharing AP provides, to a second STA associated with the sharing AP, a RTS threshold that is lower than a previously provided (or default) RTS threshold, wherein the second STA is required to perform a RTS and CTS frame exchange before transmitting when the RTS threshold is met. In an embodiment, the RTS threshold is a TXOP duration-based RTS threshold. In an embodiment, the RTS threshold is a frame size-based RTS threshold (e.g., dot11RTSthreshold).

At operation 2220, the sharing AP transmits a TXOP sharing frame to the shared AP to allocate the portion of the TXOP to the shared AP.

In an embodiment, at operation 2225, the sharing AP receives a RTS frame from the second STA during the portion of the TXOP allocated to the shared AP but refrains from responding to the RTS frame.

At operation 2230, the sharing AP receives a TXOP return frame from the shared AP.

At operation 2235, the sharing AP resumes the TXOP in response to receiving the TXOP return frame.

In an embodiment, at operation 2240, after resuming the TXOP, the sharing AP transmits a reset frame to the STA to cause the STA to stop applying the temporary channel access parameter set.

Although many of the solutions and techniques provided herein have been described with reference to a WLAN system, it should be understood that these solutions and techniques are also applicable to other network environments, such as cellular telecommunication networks, wired networks, etc. In some embodiments, the solutions and techniques provided herein may be or may be embodied in an article of manufacture in which a non-transitory machine-readable medium (such as microelectronic memory) has stored thereon instructions which program one or more data processing components (generically referred to here as a “processor” or “processing unit”) to perform the operations described herein. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

In some cases, an embodiment may be an apparatus (e.g., an AP STA, a non-AP STA, or another network or computing device) that includes one or more hardware and software logic structures for performing one or more of the operations described herein. For example, as described herein, an apparatus may include a memory unit, which stores instructions that may be executed by a hardware processor installed in the apparatus. The apparatus may also include one or more other hardware or software elements, including a network interface, a display device, etc.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system may carry out the computer-implemented methods described herein in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method performed by a sharing access point (AP) to be able to receive a transmission opportunity (TXOP) return frame during coordinated time division multiple access (c-TDMA), the method comprising:
providing a temporary channel access parameter set to a station (STA) associated with the sharing AP, wherein the temporary channel access parameter set includes a duration parameter indicating a duration for which the STA is to apply the temporary channel access parameter set, wherein the duration is sufficiently long to encompass a portion of a TXOP owned by the sharing AP that is to be allocated to a shared AP;
performing a frame exchange with the STA that causes the STA to apply the temporary channel access parameter set for the duration;
transmitting a TXOP sharing frame to the shared AP to allocate the portion of the TXOP to the shared AP;
receiving the TXOP return frame from the shared AP; and
resuming the TXOP in response to receiving the TXOP return frame.

2. The method of claim 1, further comprising:
after resuming the TXOP, transmitting a reset frame to the STA to cause the STA to stop applying the temporary channel access parameter set.

3. The method of claim 1, wherein the temporary channel access parameter set further includes an arbitrary interframe space number (AIFSN) parameter indicating that uplink transmission is prohibited.

4. The method of claim 3, wherein the AIFSN parameter is set to a value of 0 to indicate that uplink transmission is prohibited.

5. The method of claim 1, wherein the temporary channel access parameter set further includes a minimum contention window parameter indicating a minimum contention window value and a maximum contention window parameter indicating a maximum contention window value, wherein the minimum contention window value and the maximum contention window value are larger compared to a minimum contention window value and a maximum contention window value, respectively, included in a standard channel access parameter set to reduce a channel access probability of the STA.

6. The method of claim 1, further comprising:
providing, a second STA associated with the sharing AP, a request-to-send (RTS) threshold that is lower than a previously provided RTS threshold, wherein the second STA is required to perform a RTS and clear-to-send (CTS) frame exchange before transmitting when the RTS threshold is met.

7. The method of claim 6, further comprising:
receiving a RTS frame from the second STA during the portion of the TXOP allocated to the shared AP but refraining from responding to the RTS frame.

8. The method of claim 6, wherein the RTS threshold is a TXOP duration-based RTS threshold.

9. The method of claim 6, wherein the RTS threshold is a frame size-based RTS threshold.

10. The method of claim 1, wherein the providing the temporary channel access parameter set to the STA comprises transmitting a management frame, a control frame, or a quality of service (QoS) data frame to the STA that includes information regarding the temporary channel access parameter set.

11. The method of claim 1, wherein the temporary channel access parameter set is a multi-user (MU) enhanced distributed channel access (EDCA) parameter set and the frame exchange is a trigger-based frame exchange.

12. A wireless device configured to implement a sharing access point (AP), the wireless device comprising:
a radio frequency transceiver;
a memory device storing a set of instructions; and
a processor coupled to the memory device, wherein the set of instructions, when executed by the processor, causes the wireless device to:
provide a temporary channel access parameter set to a station (STA) associated with the sharing AP, wherein the temporary channel access parameter set includes a duration parameter indicating a duration for which the STA is to apply the temporary channel access parameter set, wherein the duration is sufficiently long to encompass a portion of a transmission opportunity (TXOP) owned by the sharing AP that is to be allocated to a shared AP;
perform a frame exchange with the STA that causes the STA to apply the temporary channel access parameter set for the duration;
transmit a TXOP sharing frame to the shared AP to allocate the portion of the TXOP to the shared AP;
receive a TXOP return frame from the shared AP; and
resume the TXOP in response to receiving the TXOP return frame.

13. The wireless device of claim 12, wherein the set of instructions, when executed by the processor, further causes the wireless device to:
after resuming the TXOP, transmit a reset frame to the STA to cause the STA to stop applying the temporary channel access parameter set.

14. The wireless device of claim 12, wherein the temporary channel access parameter set further includes an arbitrary interframe space number (AIFSN) parameter that is set to a value of 0 to indicate that uplink transmission is prohibited.

15. The wireless device of claim 12, wherein the temporary channel access parameter set further includes a minimum contention window parameter indicating a minimum contention window value and a maximum contention window parameter indicating a maximum contention window value, wherein the minimum contention window value and the maximum contention window value are larger compared to a minimum contention window value and a maximum contention window value, respectively, included in a standard channel access parameter set to reduce a channel access probability of the STA.

16. The wireless device of claim 12, wherein the set of instructions, when executed by the processor, further causes the wireless device to:
providing, a second STA associated with the sharing AP, a request-to-send (RTS) threshold that is lower than a previously provided RTS threshold, wherein the second STA is required to perform a RTS and clear-to-send (CTS) frame exchange before transmitting when the RTS threshold is met.

17. A non-transitory machine-readable medium having computer code stored therein, which when executed by a processor of a wireless device implementing a sharing access point (AP), causes the sharing AP to perform operations comprising:
providing a temporary channel access parameter set to a station (STA) associated with the sharing AP, wherein the temporary channel access parameter set includes a duration parameter indicating a duration for which the STA is to apply the temporary channel access parameter set, wherein the duration is sufficiently long to encompass a portion of a transmission opportunity (TXOP) owned by the sharing AP that is to be allocated to a shared AP;
performing a frame exchange with the STA that causes the STA to apply the temporary channel access parameter set for the duration;
transmitting a TXOP sharing frame to the shared AP to allocate the portion of the TXOP to the shared AP;
receiving a TXOP return frame from the shared AP; and
resuming the TXOP in response to receiving the TXOP return frame.

18. The non-transitory machine-readable medium of claim 17, wherein the operations further comprise:
after resuming the TXOP, transmitting a reset frame to the STA to cause the STA to stop applying the temporary channel access parameter set.

19. The non-transitory machine-readable medium of claim 17, wherein the operations further comprise:
providing, a second STA associated with the sharing AP, a request-to-send (RTS) threshold that is lower than a previously provided RTS threshold, wherein the second STA is required to perform a RTS and clear-to-send (CTS) frame exchange before transmitting when the RTS threshold is met.

20. The non-transitory machine-readable medium of claim 19, wherein the operations further comprise:
receiving a RTS frame from the second STA during the portion of the TXOP allocated to the shared AP but refraining from responding to the RTS frame.
